(19) United States
(12) Patent Application Publication
(10) Pub. No.: US 2025/0210665 A1
(43) Pub. Date: Jun. 26, 2025

(54) ELECTRODE MATERIAL, ELECTRODE, BATTERY AND METHOD FOR FORMING THE ELECTRODE MATERIAL

(71) Applicant: INDUSTRIAL TECHNOLOGY RESEARCH INSTITUTE, Hsinchu (TW)

(72) Inventors: Tsung-Hsiung WANG, Dali City (TW); Chang-Rung YANG, Hsinchu City (TW); Lu-Shih LIAO, Taichung City (TW); Ming-Yi LU, Hsinchu City (TW); Ming-Chin CHEN, Qionglin Township (TW); Ming-Hua WANG, Taoyuan City (TW)

(73) Assignee: INDUSTRIAL TECHNOLOGY RESEARCH INSTITUTE, Hsinchu (TW)

(21) Appl. No.: 18/967,452

(22) Filed: Dec. 3, 2024

Related U.S. Application Data
(60) Provisional application No. 63/614,860, filed on Dec. 26, 2023.

(51) Int. Cl. H01M 4/62; C08F 255/02; H01M 4/02; H01M 4/131; H01M 4/36; H01M 10/0525

(52) U.S. Cl. CPC H01M 4/622; C08F 255/026; H01M 4/131; H01M 4/366; H01M 10/0525; H01M 2004/021

(57) ABSTRACT

An electrode material, electrode, battery and method for forming the electrode material are provided. The electrode material includes an active particle and a cladding layer partially or completely covering the surface of the active particle. The cladding layer includes 5 to 70 parts by weight of a conductive additive and 30 to 95 parts by weight of a first polymer, wherein the total weight of the first polymer and the conductive additive is 100 parts by weight. The first polymer is a product of a compound having two acrylate groups and an ethylene-vinyl acetate copolymer via a polymerization. The compound having two acrylate groups has the structure as represented by Formula (I)

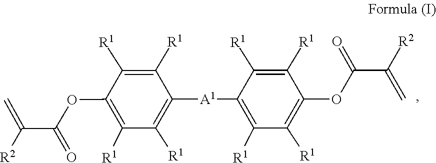

wherein A¹, R¹ and R² are disclosed in the specification.

### CROSS REFERENCE TO RELATED APPLICATIONS

This application claims the benefit of U.S. Provisional Application No. 63/614,860, filed on Dec. 26, 2023, which is hereby incorporated by reference herein in its entirety.

### TECHNICAL FIELD

The disclosure relates to an electrode material, electrode, battery and method for forming the electrode material.

### BACKGROUND

Lithium batteries have become the mainstream in commercialized batteries and are oriented toward becoming lighter, thinner, smaller, with higher energy density, longer lifespan, and greater safety.

One of the key steps in manufacturing lithium batteries is the formation of electrodes. The conventional electrode formation process includes steps such as electrode slurry preparation, electrode coating, drying, and pressing. In the electrode slurry preparation step, a mixture of electrode active material, a binder (used to bond powder-like electrode active material together and fix it onto the current collector), and a solvent (used to disperse the powder-like electrode active material and ensure sufficient contact between the binder and the powder) is prepared to form a flowable electrode slurry. After completing the electrode slurry preparation, the slurry is coated onto the current collector, the solvent contained in the electrode slurry is removed, and the coating is pressed to a predetermined thickness. However, during the drying process, when the solvent in the electrode slurry is removed, defects such as pinholes or cracks may be formed in the pre-formed electrode active layer. Furthermore, due to differences in solvent evaporation rates, the drying degree of the inner and outer parts of the electrode slurry coating may vary, leading to gaps within the electrode and reducing the quality of the obtained electrode.

In order to solve the problems caused by the traditional electrode preparation process using electrode slurry, the industry has proposed a dry electrode manufacturing technique that does not require any solvent. This process involves mixing fluorine-based binders (such as polytetrafluoroethylene (PTFE) or polyvinylidene fluoride (PVDF)) with conductive materials and electrode active materials, followed by a thermocompression process to form the electrode. However, fluorine-based binders require high-torque fibrillation treatment before use. In addition, when processing fluorine-containing dry electrode materials using thermal roll pressing, a processing temperature above 200° C. is required. Such a high processing temperature can easily cause wrinkles in the formed electrode, reducing the capacity of the obtained electrode, energy density, and stability.

### SUMMARY

According to embodiments of the disclosure, the disclosure provides an electrode material, wherein the electrode material includes an active particle, and a cladding layer. The cladding layer partially or completely covering the surface of the active particle. The cladding layer may include 5 to 70 parts by weight of a conductive additive; and 30 to 95 parts by weight of a first polymer, wherein the total weight of the first polymer and the conductive additive is 100 parts by weight. The first polymer is a product of a compound having two acrylate groups and an ethylene-vinyl acetate copolymer via a polymerization, wherein the compound having two acrylate groups having a structure represented by Formula (I)

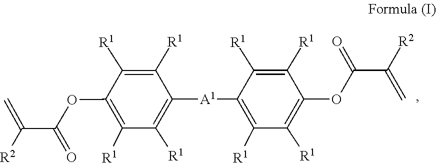

wherein A¹ may be single bond, oxygen,

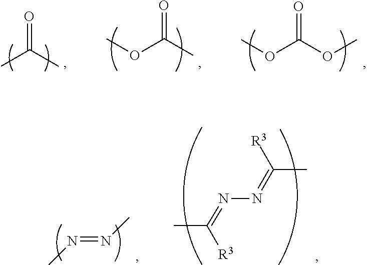

or —CH—CH—; each R¹ may be independently hydrogen or methyl; each R² may be independently hydrogen or methyl; and, each R³ may be independently hydrogen, methyl, or ethyl.

According to embodiments of the disclosure, the disclosure provides an electrode, wherein the electrode may include a current-collecting layer and an active layer. The active layer may be disposed on the current-collecting layer, wherein the active layer includes the electrode material of the disclosure.

According to embodiments of the disclosure, the disclosure provides a battery, wherein the battery includes a positive electrode, a separator, and a negative electrode, wherein the negative electrode is separated from the positive electrode by the separator, and at least one of the positive electrode and the negative electrode is the electrode of the disclosure.

According to embodiments of the disclosure, the disclosure provides a method for forming electrode material in order to prepare the electrode material of the disclosure. The method for forming electrode material includes providing a composition, wherein the composition includes the active particle, the conductive additive and the first polymer; and, subjecting the composition to a spray pelletization process or a melt blending process to obtain the electrode material.

A detailed description is given in the following embodiments.

### BRIEF DESCRIPTION OF THE DRAWINGS

The present disclosure may be more fully understood by reading the subsequent detailed description and examples with references made to the accompanying drawings, wherein:

FIG. 1 is a cross-sectional view of the electrode material according to an embodiment of the disclosure;

FIG. 2 is a cross-sectional view of the electrode material according to another embodiment of the disclosure;

FIG. 3 is a flow chart of the method for forming the electrode material according to an embodiment of the disclosure;

FIG. 4 is a schematic view of the electrode according to an embodiment of the disclosure;

FIG. 5 is a schematic view of the electrode according to another embodiment of the disclosure;

FIG. 6 is a schematic view of the battery according to an embodiment of the disclosure;

FIG. 7 is a scanning electron microscope (SEM) image of Electrode material (1);

FIG. 8 is a scanning electron microscope (SEM) image of Electrode material (8); and

FIG. 9 is a transmission electron microscope (TEM) image of Electrode material (1).

### DETAILED DESCRIPTION

The electrode material, electrode, battery and method for forming the electrode material and method for preparing the same are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Moreover, the use of ordinal terms such as “first”, “second”, “third”, etc., in the disclosure to modify an element does not by itself connote any priority, precedence, or der of one claim element over another or the temporal order in which it is formed, but are used merely as labels to distinguish one claim element having a certain name from another element having the same name (but for use of the ordinal term) to distinguish the claim elements.

It should be noted that the elements or devices in the drawings of the disclosure may be present in any form or configuration known to those skilled in the art. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The disclosure provides an electrode material suitable for electrode manufacturing processes (such as dry electrode processes) to form electrodes applicable to batteries, such as the positive or negative electrode of a lithium battery. The electrode material of the disclosure includes an active particle and a cladding layer that partially or completely covers the surface of the active particle. The cladding layer includes a first polymer and a conductive additive. It should be noted that due to the appropriate rheological properties, adhesion, and melting point of the first polymer, the conductive additive may be uniformly dispersed within the cladding layer through a spray pelletization process or melt blending process. This enables the cladding layer to cover and bond to the surface of the active particle, forming the electrode material of the disclosure. In addition, due to the specific component and structure of the electrode material of the disclosure, it may be used to form an active layer on the surface of a current-collecting layer via a dry process (such as a thermocompression process) at a relatively low operating temperature (below 200° C., or even below 150° C.) without the need of preparing an electrode slurry. That is, it does not require dispersion the electrode material of the disclosure in a solvent, or an additional binder mixing with the electrode material of the disclosure in a solvent. As a result, the formed active layer of the obtained electrode not only exhibits superior mechanical strength and adhesion (between the active layer and the current-collecting layer), but also enhances mass loading, compacted density, and stability. This overcomes issues related to uneven distribution and poor performance in wet electrode manufacturing processes, thereby improving battery capacity and energy density. Furthermore, it extends the life cycle, charge-discharge performance, and C-rate discharge ability under high temperature and high voltage operation.

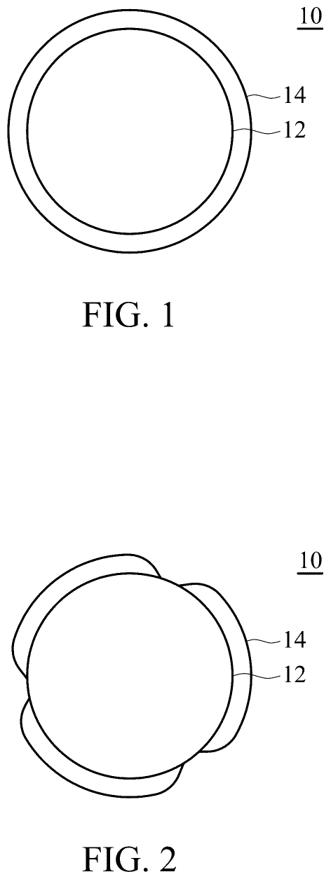

The disclosure provides an electrode material which is used in the formation of an electrode (such as negative electrodes or positive electrodes) applicable to a battery (such as lithium-ion batteries) or a lithium secondary battery. As shown in FIG. 1, a cross-sectional view of an embodiment of the electrode of the disclosure material, the electrode material 10 may include an active particle 12 and a cladding layer 14. According to embodiments of the disclosure, the cladding layer 14 may be disposed on the surface of the active particle 12 to completely cover its surface, as shown in FIG. 1. Namely, the electrode material 10 has a core-shell structure consisting of a core and a shell encapsulating the core, wherein the core is the active particle 12, and the shell layer is the cladding layer 14.

According to embodiments of the disclosure, the particle size of the active particle 12 (such as the maximum distance between any two points on its surface) may be from about 50 nm to 100 μm, for such as about 60 nm, 100 nm, 200 nm, 300 nm, 400 nm, 500 nm, 600 nm, 700 nm, 800 nm, 900 nm, 1 μm, 2 μm, 3μ, 4μ, 5 μm, 6 μm, 7μ, 8 μm, 9 μm, 10 μm, 15 μm, 20μ, 25 μm, 30 μm, 35 μm, 40 μm, 45 μm, 50 μm, or 80 μm. According to embodiments of the disclosure, the active particle may have a circular, oval, polygonal, or approximately circular cross-section. According to embodiments of the disclosure, the thickness of the cladding layer 14 (such as average thickness or the shortest distance from the outer surface of the cladding layer 14 to the surface of the active particle 12) may be from 10 nm to 5 μm, for such as about 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 2 μm, 3 μm, or 4 μm. The particle size of the active particles and the thickness of the cladding layer may be determined using an electron microscope.

According to embodiments of the disclosure, since the electrode material of the disclosure has a functional cladding layer on the surface of the active particles (serving as both a protective layer and a conductive layer) and is formed using a spray pelletization process or a melt blending process, it can reduce volume swelling, lower water absorption, enhance stability, inhibit the dissolution of metal components (such as manganese, iron, or nickel) from the active particles, and improve ion/electron conductivity.

According to embodiments of the disclosure, the cladding layer 14 may be disposed on the surface of the active particle 12 to partially or completely cover the surface of the active particle, as shown in FIG. 2. Herein, partial coverage means that the cladding layer 14 covers 30% to 100% (such as 35%, 40%, 45%, 50%, 55%, 60%, 65%, 70%, 75%, 80%, 85%, 90%, 95%, 96%, 97%, 98%, 99%, or 99.99%) of the surface of the active particle.

According to embodiments of the disclosure, the weight ratio of the cladding layer to the active particles may be from about 3:97 to 10:90, for example, 4:96, 5:95, 6:94, 7:93, 8:92, or 9:91. If the weight ratio value of the cladding layer to the active particles is too low, the covered surface area of the active particles may be insufficient, or the thickness of the cladding layer may vary significantly, leading to decreased structural toughness, stability, adhesion, and electrical performance of the obtained electrode. Conversely, if the weight ratio value is too high, mass loading and compacted density may decrease, leading to increased impedance and reduced electrical properties, capacity, and energy density of the electrode.

According to embodiments of the disclosure, the electrode material may include at least one cladding layer. For example, the electrode material may consist of active particles, a first cladding layer, and a second cladding layer, where the first cladding layer covers the active particles, and the second cladding layer covers the first cladding layer. The material composition of the first and second cladding layers may be the same or different. In some embodiments, the electrode material may also include additional cladding layers, such as layers containing electrolyte material.

According to embodiments of the disclosure, the active particle may be a positive electrode active material or a negative electrode active material, selected based on the electrical properties of the electrode to be formed. Namely, the electrode material of the disclosure may be a positive electrode active material or a negative electrode active material.

According to embodiments of the disclosure, when the active particle is a positive electrode active material, it may be sulfur, organic sulfide, sulfur-carbon composite, metal-containing lithium oxide, metal-containing lithium sulfide, metal-containing lithium selenide, metal-containing lithium telluride, metal-containing lithium silicide, metal-containing lithium boride, metal-containing lithium phosphate, or a combination thereof. The metal may be at least one selected from the group consisting of aluminum, vanadium, titanium, chromium, copper, molybdenum, niobium, iron, nickel, cobalt, and manganese. For example, the active particle may be lithium-cobalt oxide, lithium-nickel oxide, lithium-manganese oxide, lithium-cobalt-manganese oxide, lithium-nickel-cobalt oxide, lithium-nickel-manganese oxide, lithium-nickel-manganese-cobalt oxide, lithium-chromium-manganese oxide, lithium-nickel-vanadium oxide, lithium-manganese-nickel oxide, lithium-cobalt-vanadium oxide, lithium-nickel-cobalt-aluminum oxide (NMC), lithium-iron phosphate (LFP), lithium-manganese-iron phosphate (LMFP), or a combination thereof.

According to embodiments of the disclosure, when the active particle is a negative electrode active material, it may be silicon, silicon carbide, silicon-containing oxide, titanium-containing oxide, tin, tin-containing compounds, silicon alloy, carbon material, lithium, lithium alloy, metal-containing lithium carbide, metal-containing lithium nitride, or a combination thereof. The metal may be at least one selected from the group consisting of aluminum, chromium, copper, iron, nickel, cobalt, and manganese. According to embodiments of the disclosure, the carbon material may include metastable phase spherical carbon (MCMB), vapor-grown carbon fiber (VGCF), carbon nanotube (CNT), coke, carbon black, graphite, graphene, fluorocarbon, acetylene black, carbon fiber, vitreous carbon, or a combination thereof. According to embodiments of the disclosure, the carbon nanotube may be a single-walled carbon nanotube (SWCNT), double-walled carbon nanotube (DWCNT), multi-walled carbon nanotube (MWCNT), or a combination thereof. According to embodiments of the disclosure, the silicon-containing oxide may be, for example, silicon oxycarbide. According to embodiments of the disclosure, the lithium alloy or metal-containing lithium nitride may be lithium-aluminum alloy, lithium-magnesium alloy, lithium-zinc alloy, lithium-bismuth alloy, lithium-cadmium alloy, lithium-antimony alloy, silicon-containing lithium alloy, lithium-lead alloy, tin-containing lithium alloy, lithium-iron nitride, lithium-cobalt nitride, or lithium-copper nitride.

According to embodiments of the disclosure, the cladding layer may include 5 to 70 parts by weight (such as 8, 10, 15, 20, 25, 30, 35, 40, 45, 50, 55, 60, or 65 parts by weight) of a conductive additive and 30 to 95 parts by weight (such as 32, 35, 40, 45, 50, 55, 60, 65, 70, 75, 80, 85, or 90 parts by weight) of a first polymer. Herein, the total weight of the first polymer and the conductive additive is 100 parts by weight. If the additive amount of the first polymer is too low, it may lead to reduced structural toughness, stability, adhesion, and electrode free-standing properties of the electrode material. If the additive amount of the first polymer is too high, it may cause a decrease in the mass loading, compacted density, electrical properties, capacity, and energy density of the subsequently formed electrode.

According to embodiments of the disclosure, the conductive additive is uniformly dispersed in the first polymer. The conductive additive may be an electron-conductive additive, an ion-conductive additive, or a combination thereof. For example, the conductive additive may be a combination of an electron-conductive additive and an ion-conductive additive. In the disclosure, an electron-conductive additive refers to an additive that has electron-conductive properties. The electron-conductive additive of the disclosure may also simultaneously have ion-conductive properties. If its electron-conductive properties are superior to its ion-conductive properties (or if a person skilled in the art considers the material a electron-conductive material), it is still referred to as an electron-conductive additive in the disclosure. Conversely, an ion-conductive additive refers to an additive that has ion-conductive properties. The ion-conductive additive of the disclosure may also simultaneously have electron-conductive properties. If its ion-conductive properties are superior to its electron-conductive properties (or if a person skilled in the art considers the material an ion-conductive material), it is still referred to as an ion-conductive additive in the disclosure.

According to embodiments of the disclosure, the electron-conductive additive may be an electron-conductive polymer material, an electron-conductive inorganic material, or a combination thereof. The conductivity of the electron-conductive additive may be greater than or equal to 10 S/cm (such as 15 S/cm, 20 S/cm, 25 S/cm, 30 S/cm, 35 S/cm, 40 S/cm, 45 S/cm, 50 S/cm, 55 S/cm, 60 S/cm, 65 S/cm, 70 S/cm, 75 S/cm, or 80 S/cm). The electron-conductive polymer material may be polyacetylene, polydiacetylene, polyaniline, polypyrrole, polythiophene, or a combination thereof. The weight average molecular weight of the electron-conductive polymer material is not limited and may be modified by a person skilled in the field as needed. The weight average molecular weight (Mw) of the electron-conductive polymer material may be from about 10,000 g/mol to 5,000,000 g/mol, such as about 30,000 g/mol, 50,000 g/mol, 80,000 g/mol, 100,000 g/mol, 200,000 g/mol, 300,000 g/mol, 400,000 g/mol, 500,000 g/mol, 800,000 g/mol, 1,000,000 g/mol, 2,000,000 g/mol, 3,000,000 g/mol, or 4,000,000 g/mol. The weight average molecular weight (Mw) may be determined by gel permeation chromatography (GPC) based on a polystyrene calibration curve.

According to embodiments of the disclosure, the electron-conductive inorganic material may be electron-conductive carbon black, electron-conductive graphite, fluorocarbon, reduced graphene, nitrogen-doped graphite, nitrogen-doped graphene, carbon fiber, carbon nanotube, or a combination thereof. The electron-conductive inorganic material may be particulate, with a particle size distribution D90 ranging from about 0.1 nm to 200 nm, such as about 0.2 nm, 0.5 nm, 1 nm, 2 nm, 5 nm, 10 nm, 20 nm, 30 nm, 50 nm, 80 nm, 100 nm, 120 nm, 150 nm, 170 nm, or 190 nm. The particle size distribution D90 indicates that 90% of the total volume of the electron-conductive inorganic material has a particle size less than the defined D90 value. The particle size distribution D90 is determined according to ISO 13322-1:2004.

According to embodiments of the disclosure, the ion-conductive additive may have an ionic conductivity of 1×10⁻⁶ S/cm to 9×10⁻³ S/cm (such as 2×10⁻⁶ S/cm, 5×10⁻⁶ S/cm, 8×10⁻⁶ S/cm, 1×10⁻⁵ S/cm, 2×10⁻⁵ S/cm, 5×10⁻⁵ S/cm, 8×10⁻⁵ S/cm, 1×10⁻⁴ S/cm, 2×10⁻⁴ S/cm, 5×10⁻⁴ S/cm, 8×10⁻⁴ S/cm, 1×10⁻³ S/cm, 2×10⁻³ S/cm, 5×10⁻³ S/cm, or 8×10⁻³ S/cm). The ion-conductive additive may be a hyperbranched polymer, ethyl cellulose resin, lithium-ion-containing polythiophene polymer, polymer having lithium sulfonate groups, polymer having organosilicon groups, or a combination thereof.

According to embodiments of the disclosure, the hyperbranched polymer of the disclosure may be a nitrogen-containing hyperbranched polymer. The hyperbranched polymer may be formed by polymerizing a maleimide compound. In addition, according to embodiments of the disclosure, the hyperbranched polymer may be formed by copolymerizing a maleimide compound with a barbituric acid. The maleimide compound may be bismaleimide (such as N,N′-bismaleimide-4,4′-diphenylmethane), maleimide (such as benzyl maleimide), or a combination thereof. For example, the nitrogen-containing hyperbranched polymer may be a copolymer of bismaleimide and barbituric acid or a copolymer of a maleimide oligomer and barbituric acid. According to embodiments of the disclosure, the hyperbranched polymer and its preparation may refer to Taiwan Patent I722747. According to embodiments of the disclosure, the lithium-ion-containing polythiophene polymer may include a repeating unit having a structure of

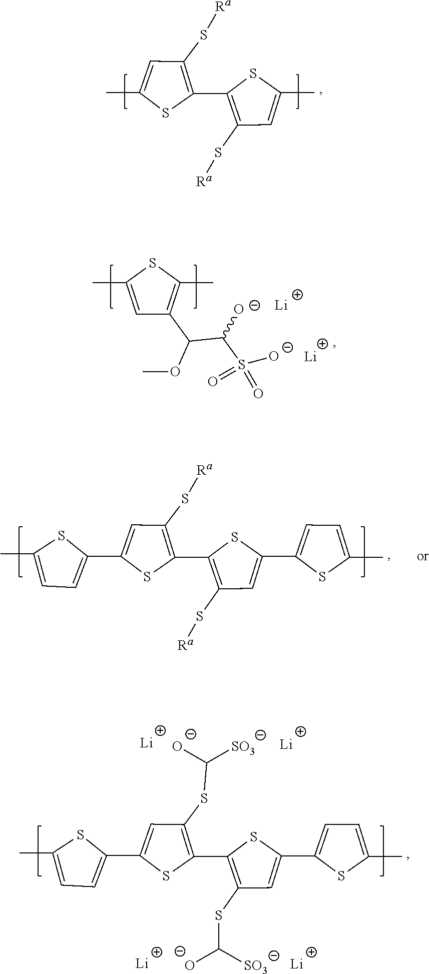

wherein R^{a} is C6-C30 alkyl group. According to embodiments of the disclosure, the lithium-ion-containing polythiophene polymer and the preparation method thereof may refer to Taiwan Patent I724715. According to embodiments of the disclosure, the polymer having a lithium sulfonate group may be poly(2-acrylamido-2-methyl-1-propanesulfonic acid lithium salt), poly(styrenesulfonic acid lithium salt), poly(vinylsulfonic acid lithium salt), poly(perfluorosulfonic acid lithium salt), poly((methyl) acrylic acid lithium salt), poly(lithium maleate), poly(lithium fumarate), poly(lithium itaconate), poly(lithium adipate), acrylonitrile/butadiene/lithium acrylate copolymer, tert-butyl acrylate/ethyl acrylate/lithium methacrylate copolymer, ethylene/lithium acrylate copolymer, methyl methacrylate/lithium methacrylate copolymer, or a combination thereof. According to embodiments of the disclosure, the polymer having an organosilicon group may be a polyester-modified polysiloxane, a polyester-polysiloxane graft copolymer, or a combination thereof. According to embodiments of the disclosure, the polymer having an organosilicon group and the preparation method thereof may refer to Taiwan Patent I445739.

According to the disclosure, a weight average molecular weight of the ion-conductive polymer (i.e., hyperbranched polymer, ethyl cellulose resin, lithium-ion-containing polythiophene polymer, polymer having a lithium sulfonate group, or polymer having an organosilicon group) is not limited and may be optionally modified by a person of ordinary skill in the field on the premise of maintaining ionic conductivity. According to embodiments of the disclosure, the weight average molecular weight (Mw) of the ion-conductive polymer may be from about 10,000 g/mol to 5,000,000 g/mol, such as about 30,000 g/mol, 50,000 g/mol, 80,000 g/mol, 100,000 g/mol, 200,000 g/mol, 300,000 g/mol, 400,000 g/mol, 500,000 g/mol, 800,000 g/mol, 1,000,000 g/mol, 2,000,000 g/mol, 3,000,000 g/mol, or 4,000,000 g/mol. The weight average molecular weight (Mw) of the ion-conductive polymer material may be determined by gel permeation chromatography (GPC) based on a polystyrene calibration curve.

According to embodiments of the disclosure, the cladding layer may consist of the first polymer and the conductive additive. According to other embodiments, the cladding layer may substantially consist of the first polymer and the conductive additive, meaning that the total weight of the first polymer and the conductive additive accounts for more than 95 wt % of the cladding layer. When the cladding layer includes other components, such components may be additives conventionally used for forming electrodes. According to embodiments of the disclosure, the electrode material of the disclosure does not include a fluorine-containing polymer. Namely, the active particle does not include a fluorine-containing polymer, and the cladding layer also does not include a fluorine-containing polymer.

According to embodiments of the disclosure, in addition to the first polymer and the conductive additive, the cladding layer may further include 0.1 to 30 parts by weight (such as 0.5, 1, 2, 3, 5, 10, 15, 20, or 25 parts by weight) of a second polymer, based on 100 parts by weight of the total weight of the first polymer and the conductive additive. The second polymer refers to a polymer added during the spray pelletization or melt blending process. Therefore, the second polymer and the first polymer are mixed and independently present in the cladding layer (the second polymer does not react with the first polymer). According to embodiments of the disclosure, due to the addition of the second polymer, the mechanical strength, resistance to liquid electrolyte erosion, wettability and penetration to the liquid electrolyte, electrochemical stability, safety protection, and adhesion of the cladding layer may be adjusted. According to embodiments of the disclosure, the first polymer and the second polymer are distinct from each other.

According to embodiments of the disclosure, the weight average molecular weight (Mw) of the first polymer may be from about 12,000 g/mol to 10,000,000 g/mol, such as about 15,000 g/mol, 20,000 g/mol, 50,000 g/mol, 80,000 g/mol, 100,000 g/mol, 200,000 g/mol, 300,000 g/mol, 400,000 g/mol, 500,000 g/mol, 800,000 g/mol, 1,000,000 g/mol, 2,000,000 g/mol, 3,000,000 g/mol, 4,000,000 g/mol, 5,000,000 g/mol, 8,000,000 g/mol, or 9,000,000 g/mol. The weight average molecular weight (Mw) of the first polymer may be determined by gel permeation chromatography (GPC) based on a polystyrene calibration curve.

According to embodiments of the disclosure, the first polymer may be a product of a compound having two acrylate groups and an ethylene-vinyl acetate copolymer via polymerization.

According to embodiments of the disclosure, the first polymer is a product of a composition via polymerization, wherein the composition includes the compound having two acrylate groups and the ethylene-vinyl acetate copolymer. According to embodiments of the disclosure, besides the compound having two acrylate groups and the ethylene-vinyl acetate copolymer, the composition may include a solvent, a reaction initiator, or a catalyst. According to some embodiments of the disclosure, the only polymerizable components in the composition are the compound having two acrylate groups and the ethylene-vinyl acetate copolymer. The solvent, reaction initiator, or catalyst may be conventionally used in olefin polymerization. For example, the solvent may be 1-methyl-2-pyrrolidinone (NMP), N,N-dimethylformamide (DMF), N,N-dimethylacetamide (DMAc), pyrrolidone, N-dodecylpyrrolidone, γ-butyrolactone, 1,2-propanediol monomethyl ether acetate, toluene, xylene, cyclopentanone, or a combination thereof. According to embodiments of the disclosure, when the composition includes a solvent, the solid content of the composition may be from about 1 wt % to 90 wt % (such as about 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, or 85 wt %). Herein, the solid content refers to the weight percentage of all components in the composition except for the organic solvent, based on the total weight of the composition. According to embodiments of the disclosure, the composition consists of the compound having two acrylate groups, the ethylene-vinyl acetate copolymer, a solvent, and a reaction initiator

According to embodiments of the disclosure, besides the compound having two acrylate groups and the ethylene-vinyl acetate copolymer, the composition used to prepare the first polymer may further include a reactive monomer or a third polymer, wherein the reactive monomer or the third polymer may react with the compound having two acrylate groups and/or the ethylene-vinyl acetate copolymer. Namely, the polymerizable components in the composition may include the compound having two acrylate groups, the ethylene-vinyl acetate copolymer, and the reactive monomer (or the third polymer). According to embodiments of the disclosure, due to the addition of the reactive monomer and/or the third polymer, the structure toughness, adhesion, rheology, electrochemical stability, and processability of the obtained first polymer may be adjusted.

According to embodiments of the disclosure, compound having two acrylate groups may have a structure of Formula (I)

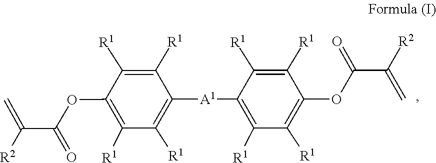

wherein A¹ may be single bond, oxygen,

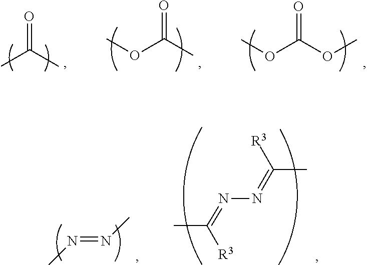

or —CH═CH—; each R¹ may be independently hydrogen or methyl; each R² may be independently hydrogen or methyl; and, each R³ may be independently hydrogen, methyl or ethyl.

According to embodiments of the disclosure, the compound having two acrylate groups may be

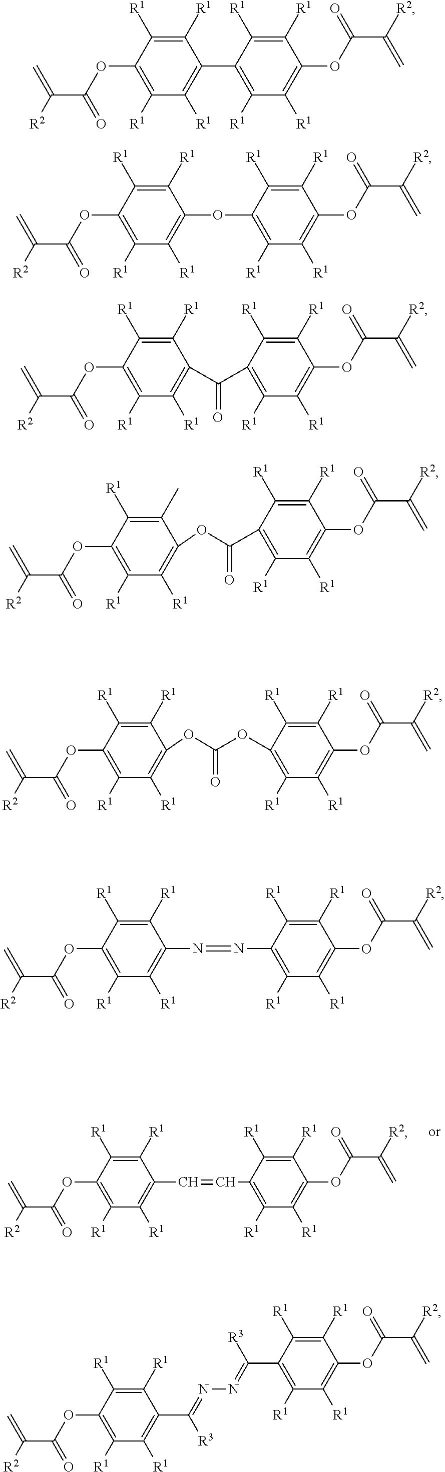

wherein R¹, R², and R³ are the same as defined above.

According to embodiments of the disclosure, the ethylene-vinyl acetate copolymer may include a repeating unit having a structure of Formula (II) or a repeating unit having a structure of Formula (III)

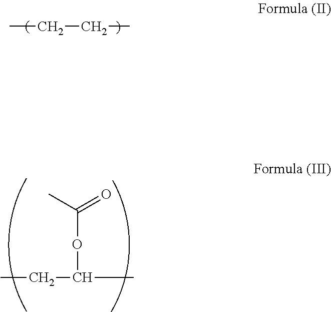

wherein the number ratio of the repeating unit having the structure of Formula (II) to the repeating unit having the structure of Formula (III) is from 1:1,250 to 300:1, for example, 1:1,000, 1:900, 1:800, 1:700, 1:500, 1:250, 1:100, 1:50, 1:25, 1:10, 1:8, 1:5, 1:3, 1:2, 1:1, 2:1, 3:1, 5:1, 8:1, 10:1, 15:1, 20:1, 25:1, 80:1, 100:1, 150:1, 200:1, or 250:1. According to embodiments of the disclosure, the first repeating unit and the second repeating unit of the ethylene-vinyl acetate copolymer may be arranged in a random or block manner.

According to embodiments of the disclosure, the ethylene-vinyl acetate copolymer has a number of n of the repeating unit having the structure of Formula (II) and a number of m of the repeating unit having the structure of Formula (III), wherein n may be from 300 to 300,000 (such as 500, 1,000, 2,000, 3,000, 5,000, 8,000, 10,000, 10,000, 15,000, 20,000, 30,000, 50,000, 70,000, 80,000, 90,000, 100,000, 150,000, 200,000, or 250,000); and m may be from 1,000 to 250,000 (such as 1500, 2,000, 3,000, 5,000, 8,000, 10,000, 10,000, 15,000, 20,000, 30,000, 50,000, 70,000, 80,000, 90,000, 100,000, 150,000, or 200,000).

According to the embodiment of the present disclosure, the weight average molecular weight of the ethylene-vinyl acetate copolymer can be from about 90,000 g/mol to 30,000,000 g/mol, such as about 100,000 (g/mol), 200,000 (g/mol), 300,000 (g/mol), 400,000 (g/mol), 500,000 (g/mol), 800,000 (g/mol), 1,000,000 (g/mol), 2,000,000 (g/mol), 3,000,000 (g/mol), 4,000,000 (g/mol), 5,000,000 (g/mol), 8,000,000 (g/mol), 10,000,000 (g/mol), 12,000,000 (g/mol), 15,000,000 (g/mol), 20,000,000 (g/mol), or 25,000,000 (g/mol). The weight average molecular weight (Mw) of the ethylene-vinyl acetate copolymer can be measured using gel permeation chromatography (GPC) with polystyrene as the standard for the calibration curve. According to the embodiment of the present disclosure, during the copolymerization process, the ethylene-vinyl acetate copolymer dissociates into reactive lower molecular weight substances at first.

According to embodiments of the disclosure, the ethylene-vinyl acetate copolymer may have a melt flow index (MI) from about 1 g/10 min to 2,000 g/10 min, such as about 200 g/10 min, 300 g/10 min, 400 g/10 min, 500 g/10 min, 800 g/10 min, 1,000 g/10 min, 1,200 g/10 min, 1,500 g/10 min, or 1,700 g/10 min. A higher melt flow index results in better fluidity, thereby making the encapsulation process more comprehensive. However, it is less likely to form fiber-like structural morphology. Further, a lower melt flow index results in poorer fluidity, which may limit encapsulation but makes fiber-like structures easier to form under shear force. When the melt flow index of the ethylene-vinyl acetate copolymer falls within the specified range, the resulting electrode material can achieve comprehensive encapsulation, high adhesion, high structural toughness, and binder-free advantages. In addition, the active particles can form tighter contact with the conductive additive, thereby enhancing the electrical performance of the electrode material. As a result, lithium ions can intercalate and deintercalate more efficiently at the active material surface, improving battery capacity and discharge rate performance. According to embodiments of the disclosure, the melt flow index of the ethylene-vinyl acetate copolymer is measured according to ASTM D1238 under a load of about 2.16 kg at about 190° C.

According to embodiments of the disclosure, the weight ratio of the compound having two acrylate groups to the ethylene-vinyl acetate copolymer may be from about 1:99 to 99:1, such as about 2:98, 3:97, 4:96, 5:95, 6:94, 7:93, 8:92, 9:91, 1:9, 2:8, 3:7, 4:6, 5:5, 6:4, 7:3, 8:2, 9:1, 91:9, 92:8, 93:7, 94:6, 95:5, 96:4, 97:3, or 98:2. When a homopolymer of the compound having two acrylate groups is used instead of the first polymer in electrode material preparation, the obtained electrode material may exhibit excessive brittleness (i.e., insufficient flexibility and viscoelasticity), poorer electrochemical stability, and structural degradation due to cracking at high processing temperatures. Conversely, when the ethylene-vinyl acetate copolymer is used instead of the first polymer in electrode material preparation, the resulting electrode material may be too soft, leading to insufficient strength, deformation, aging, and poor thermal stability, with the release of corrosive decomposition products at high processing temperatures.

According to embodiments of the disclosure, the second polymer may be polyamide, polyimide, polymaleimide, polybismaleimide, polyacrylate, polyacrylic acid (PAA), polyvinyl alcohol (PVA), sodium carboxymethyl cellulose (CMC), polystyrene, styrene-butadiene rubber, polyurethane, polyethylene-based polyvinylpyrrolidone, polyvinyl chloride (PVC), polyacrylonitrile (PAN), polybutadiene, or combinations thereof. According to embodiments of the disclosure, the weight average molecular weight of the second polymer may be from about 2,000 g/mol to 3,000,000 g/mol, such as about 3,000 g/mol, 5,000 g/mol, 8,000 g/mol, 10,000 g/mol, 12,000 g/mol, 15,000 g/mol, 20,000 g/mol, 50,000 g/mol, 80,000 g/mol, 100,000 g/mol, 200,000 g/mol, 300,000 g/mol, 400,000 g/mol, 500,000 g/mol, 800,000 g/mol, 1,000,000 g/mol, 2,000,000 g/mol, or 2,500,000 g/mol. The weight average molecular weight (Mw) of the second polymer may be determined by gel permeation chromatography (GPC) based on a polystyrene calibration curve.

According to embodiments of the disclosure, the reactive monomer may be ethylene, propylene, isobutylene, 1-butene, ethyl acetate, acrylic acid, acrylates, alkenyl aromatic monomers, maleimide, bismaleimide, barbituric acid, or combinations thereof.

According to embodiments of the disclosure, the third polymer may be polyacrylate, polyacrylic acid (PAA), polyvinyl alcohol (PVA), sodium carboxymethyl cellulose (CMC), ethyl cellulose, polystyrene, styrene-butadiene rubber, polybutadiene, or combinations thereof. The weight average molecular weight of the third polymer may be from about 2,000 g/mol to 3,000,000 g/mol, such as about 3,000 g/mol, 5,000 g/mol, 8,000 g/mol, 10,000 g/mol, 12,000 g/mol, 15,000 g/mol, 20,000 g/mol, 50,000 g/mol, 80,000 g/mol, 100,000 g/mol, 200,000 g/mol, 300,000 g/mol, 400,000 g/mol, 500,000 g/mol, 800,000 g/mol, 1,000,000 g/mol, 2,000,000 g/mol, or 2,500,000 g/mol. The weight average molecular weight (Mw) of the third polymer may be determined by gel permeation chromatography (GPC) based on a polystyrene calibration curve.

According to embodiments of the disclosure, the preparation of the first polymer may include the following steps. First, a compound having two acrylate groups and an ethylene-vinyl acetate copolymer are dispersed in a solvent, and an initiator and/or catalyst may optionally be added to obtain a composition. Next, the composition is heated to allow the compound having two acrylate groups to react with the ethylene-vinyl acetate copolymer, forming the first polymer.

According to other embodiments of the disclosure, the preparation of the first polymer may include the following steps. First, a compound having two acrylate groups and an ethylene-vinyl acetate copolymer are dispersed in a solvent, and a reactive monomer, a third polymer, an initiator, and/or a catalyst may optionally be added to obtain a composition. Next, the composition is heated to allow the compound having two acrylate groups to react with the ethylene-vinyl acetate copolymer, forming the first polymer.

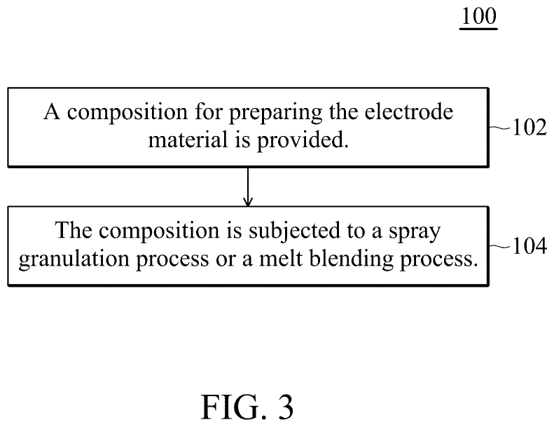

According to embodiments of the disclosure, as shown in FIG. 3, the method 100 for preparing the electrode material may include the following steps. First, a composition for preparing the electrode material is provided, wherein the composition includes active particles, a conductive additive, and the first polymer (step 102). Next, the composition is subjected to a spray pelletization process or a melt blending process to obtain the electrode material (step 104). According to embodiments of the disclosure, in the composition, the weight ratio of the conductive additive to the first polymer is 5:95 to 70:30, for example, 10:90, 20:80, 30:70, 40:60, 50:50, or 60:40. According to embodiments of the disclosure, the weight ratio of the total weight of the conductive additive and the first polymer to the active particle weight is from 4:96 to 10:90, for example, 5:95 to 7:30, such as 5:95, 6:94, 7:93, 8:92, or 9:91. In addition, the composition further comprises a second polymer, where the total weight of the conductive additive, the first polymer, and the second polymer relative to the active particle weight is from 3:97 to 10:90, for example, 4:96, 5:95, 6:94, 7:93, 8:92, or 9:91. According to embodiments of the disclosure, since the electrode material is formed from the composition used to prepare the electrode material, the weight ratio of the conductive additive to the first polymer in the composition is about equal to the weight ratio of the conductive additive to the first polymer in the cladding layer; and the weight ratio of the total weight of the conductive additive and the first polymer (or the total weight of the conductive additive, the first polymer, and the second polymer) to the active particles in the composition is about equal to the weight ratio of the cladding layer to the active particles in the electrode material.

According to embodiments of the disclosure, the method for forming the electrode material includes the following steps. First, a first composition for preparing the electrode material is provided, wherein the first composition includes the active particle, the conductive additive, and the first polymer. Next, the first composition is subjected to a spray pelletization process to obtain core-shell particles (consisting of the active particles and the first cladding layer). Next, the core-shell particles are mixed with another conductive additive and another first polymer to obtain a second composition. Next, the the second composition is subjected to a spray pelletization process to obtain the electrode material of the disclosure.

According to embodiments of the disclosure, since the electrode material of the disclosure is formed via a spray pelletization process or a melt blending process, it can reduce the volume swelling phenomenon of the electrode prepared from the electrode material, lower water absorption, increase stability, inhibit the dissolution of metal components (such as manganese, iron, or nickel) from active particles, and improve ion-conductive/electron-conductive performance.

According to embodiments of the disclosure, when the electrode material is prepared by the spray pelletization process, the method for forming the electrode material includes the following steps. First, the conductive additive is uniformly dispersed in a solvent to obtain a first solution. Next, the active particle is added to the first solution and uniformly dispersed to obtain a second solution. Next, the first polymer (or a combination of the second polymer and the first polymer) is added to the second solution and uniformly mixed to obtain a slurry. Next, the slurry is subjected to a spray pelletization process to obtain the electrode material. According to embodiments of the disclosure, the atomization nozzle diameter, atomizer frequency, operating temperature, inlet temperature, outlet temperature, and feed flow rate used in the spray pelletization process may be optionally adjusted by those skilled in the art. For example, a closed-loop inert gas circulation spray drying system (CL-8 model) from Okawara Mfg. Co., Ltd. and a centrifugal ceramic pin atomizer plate (MC-50-8-14C) may be used. The atomizer rotation frequency may range from 20 Hz to 60 Hz; the operating temperature may range from 50° C. to 200° C.; the inlet temperature may range from 30° C. to 200° C.; the outlet temperature may range from 30° C. to 200° C.; and the feed flow rate may range from 1 ml/min to 100 ml/min. In addition, the spray pelletization process may include a drying step to dry the product after pelletization, wherein the drying temperature may be adjusted according to the solvent used, such as 50° C. to 200° C. For example, the spray pelletization process can be conducted using a spray drying system. The solvent may be 1-methyl-2-pyrrolidone (NMP), N,N-dimethylformamide (DMF), N,N-dimethylacetamide (DMAc), pyrrolidone, N-dodecylpyrrolidone, γ-butyrolactone (γ-GBL), 1,2-propanediol monomethyl ether acetate, toluene, xylene, cyclopentanone, or a combination thereof.

According to embodiments of the disclosure, when the electrode material is prepared by the melt blending process, the method for forming the electrode material includes the following steps. First, the conductive additive, active particle, and first polymer (or further including the second polymer) are thoroughly mixed to obtain a mixture. Next, the mixture is subjected to a melt blending process to obtain the electrode material. Herein, the term “melt” refers to heating to the melting point of the first polymer reactant or heating above the temperature where the first polymer becomes deformable, resulting in a fluid state. the term “blending” refers to the process of uniformly mixing the conductive additive, active particles, and polymer through mechanical means (such as an extruder), which can be performed in a continuous or batch method. According to embodiments of the disclosure, since the disclosure uses a specific polymer (i.e., the first polymer) to prepare the electrode material, the temperature of the melt blending process may range from 60° C. to 200° C., such as about 70° C., 80° C., 90° C., 100° C., 110° C., 120° C., 130° C., 140° C., 150° C., 160° C., 170° C., 180° C., or 190° C.

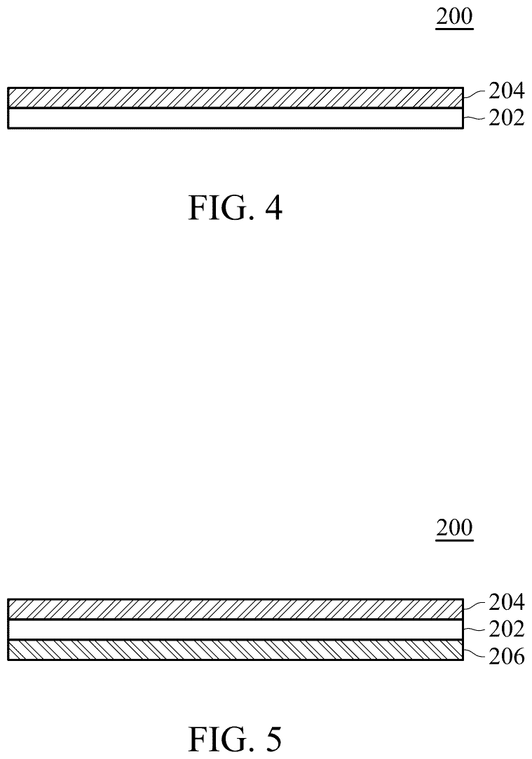

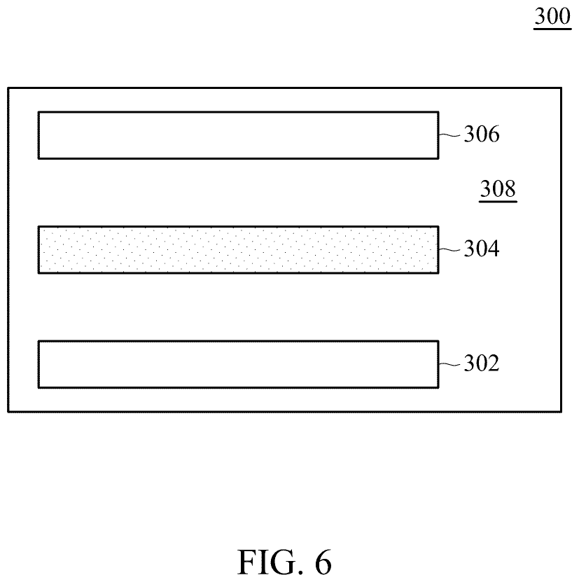

According to embodiments of the disclosure, the disclosure also provides an electrode (such as a positive electrode or a negative electrode) for a battery (such as a lithium-ion battery or a lithium secondary battery). As shown in FIG. 4, the electrode 200 includes a current-collecting layer 202 and an active layer 204, wherein the active layer 204 is disposed on the current-collecting layer 202. The active layer 204 is directly disposed on the current-collecting layer 202, resulting in that the bottom surface of the active layer 204 directly contact the top surface of the current-collecting layer 202 (i.e., there is no film layer (continuous or non-continuous) between the active layer 204 and the current-collecting layer 202). For example, the active layer 204 and the current-collecting layer 202 have good adhesion, thereby eliminating the need for an additional adhesive or bonding layer to fix the active layer 204 onto the current-collecting layer 202 or the need to mix the electrode material with a binder to form the active layer. The electrode 200 consists of the current-collecting layer 202 and the active layer 204, wherein the active layer 204 consists of the electrode material.

According to embodiments of the disclosure, the electrode 200 may include two active layers (i.e., the first active layer 204 and the second active layer 206) and a current-collecting layer 202, wherein the current-collecting layer 202 is disposed between the two active layers 204. Herein, the first active layer 204 is directly disposed on the current-collecting layer 202, and the bottom surface of the first active layer 204 directly contacts the top surface of the current-collecting layer 202; and, the current-collecting layer 202 is directly disposed on the second active layer 206, and the bottom surface of the current-collecting layer 202 directly contacts the top surface of the second active layer 206.

According to embodiments of the disclosure, the electrode of the disclosure may be used as the positive electrode of a battery, wherein the electrode material used for the active layer has active particles that are positive electrode active materials. According to embodiments of the disclosure, the electrode of the disclosure may be used as the negative electrode of a battery, wherein the electrode material used for the active layer has active particles that are negative electrode active materials.

According to embodiments of the disclosure, the thickness of the active layer is not limited and may be optionally adjusted by a person of ordinary skill in the field. For example, the thickness of the active layer may be from about 50 μm to 500 μm (such as about 70 μm, 100 μm, 120 μm, 150 μm, 180 μm, 200 μm, 250 μm, 300 μm, 350 μm, 400 μm, or 450 μm).

According to embodiments of the disclosure, the current-collecting layer may be a conductive carbon substrate, metal foil (such as nickel foil, aluminum foil, copper foil, carbon-coated aluminum foil, or stainless steel foil), or a metal material with a porous structure, such as carbon cloth, carbon felt, carbon paper, nickel mesh, copper mesh, molybdenum mesh, foamed nickel, foamed copper, or foamed molybdenum. According to embodiments of the disclosure, the metal material with a porous structure may have a porosity of about 10% to 99.9% (such as 20%, 30%, 40%, 50%, 60%, 70%, 80%, or 90%). According to embodiments of the disclosure, the thickness of the current-collecting layer is not limited and may be optionally adjusted by a person of ordinary skill in the field. For example, the thickness of the current-collecting layer may be from about 5 μm to 50 μm (such as about 6 μm, 7 μm, 8 μm, 9 μm, 10 μm, 15 μm, 20 μm, 25 μm, 30 μm, 35 μm, 40 μm, or 45 μm).

According to embodiments of the disclosure, the method for preparing the electrode of the disclosure may include the following steps. The electrode material of the disclosure and a current-collecting layer are provided. Next, the electrode material is applied to the current-collecting layer and subjected to a thermocompression process, converting the electrode material into an active layer to form the electrode, wherein the active layer is in direct contact with the current-collecting layer. According to embodiments of the disclosure, the thermocompression process may include thermal rolling or thermal pressing. Since each electrode material particle of the disclosure has a cladding layer and the cladding layer contains the first polymer of the disclosure, thus the active particles, electron-conductive additives, and first polymer naturally achieve uniform mixing. In addition, due to its specific chemical structure, the first polymer of the disclosure has an appropriate melting point, rheological properties, and adhesiveness, allowing the thermocompression process to proceed at a lower temperature. According to embodiments of the disclosure, the operating temperature of the thermocompression process may be from about 80° C. to 200° C., such as about 90° C., 100° C., 110° C., 120° C., 130° C., 140° C., 150° C., 160° C., 170° C., 180° C., or 190° C. According to embodiments of the disclosure, the pressure applied during the thermocompression process may be optionally adjusted by a person of ordinary skill in the field. For example, the pressure applied in the thermocompression process may be greater than or equal to 100 psi. The electrode of the disclosure avoids issues caused by additional binder use and improves the uniformity of mixing between the active material and conductive material. Therefore, it enhances the mass loading, compacted density, and stability of the resulting electrode (i.e., solving the problems associated with wet-process electrode manufacturing).

According to embodiments of the disclosure, the method for preparing the electrode of the disclosure may include the following steps. The electrode material of the disclosure and a current-collecting layer are provided. Next, the electrode material is subjected to a thermocompression process to form an electrode material film. Next, the electrode material film is applied to the current-collecting layer and the electrode material is subjected to a thermocompression process, converting the electrode material film into an active layer to form the electrode, wherein the active layer is in direct contact with the current-collecting layer. According to embodiments of the disclosure, the thermocompression process may include a thermal rolling process or a thermal milling process.

According to embodiments of the disclosure, the method for preparing the electrode of the disclosure may include the following steps. A composition for preparing the electrode material and a current-collecting layer are provided. The composition includes active particles, a conductive additive, and the first polymer of the disclosure. Next, the composition is subjected to a spray granulation process, and the electrode material is formed directly onto the current-collecting layer using the spray granulation process. Next, the electrode material is subjected to a thermocompression process, converting into an active layer to form the electrode.

According to the embodiment of the present disclosure, the method for forming the electrode of the disclosure may include the following steps. A composition for preparing the electrode material and a current-collecting layer are provided, wherein the composition includes the active particles, the conductive additive, and the first polymer. The composition is then introduced into a melt mixing process, and the extruded electrode material is directly coated onto the current-collecting layer. Subsequently, the electrode material is subjected to a thermal pressing process to transform it into an active layer, resulting in the electrode.

According to embodiments of the disclosure, as shown in FIG. 5, the disclosure also provides a battery 300, such as a lithium battery, lithium-ion battery, or lithium secondary battery. The battery 300 includes a positive electrode 302, a separator 304, and a negative electrode 306, wherein the negative electrode 306 is separated from the positive electrode 302 by the separator 304. According to embodiments of the disclosure, at least one of the positive electrode 302 and the negative electrode 306 is the electrode of the disclosure. When the positive electrode 302 is the electrode of the disclosure, then in the positive electrode 302, the electrode material used in the active layer has active particles that are positive electrode active materials. When the negative electrode 306 is the electrode of the disclosure, then in the negative electrode 306, the electrode material used in the active layer has active particles that are negative electrode active materials.

According to embodiments of the disclosure, when the positive electrode is not the electrode of the disclosure, the positive electrode may be a conventional positive electrode used in batteries (such as lithium batteries). For example, the positive electrode may include a positive electrode active layer (containing a positive electrode active material) and a positive electrode current-collecting layer. According to embodiments of the disclosure, when the negative electrode is not the electrode of the disclosure, the negative electrode may be a conventional negative electrode used in batteries (such as lithium batteries). For example, the negative electrode may include a negative electrode active layer (containing a negative electrode active material) and a negative electrode current-collecting layer. According to embodiments of the disclosure, the definitions of the positive electrode current-collecting layer and the negative electrode current-collecting layer may be the same as the current-collecting layer of the disclosure.

According to embodiments of the disclosure, the positive electrode 302 may be in direct contact with the separator 304 and/or the negative electrode 306 may be in direct contact with the separator 304. According to embodiments of the disclosure, the positive electrode 302 may be separated from the separator 304 by a certain distance and/or the negative electrode 306 may be separated from the separator 304 by a certain distance. According to embodiments of the disclosure, the battery 300 may further include a liquid electrolyte 308, which is disposed between the positive electrode 302 and the negative electrode 306. Namely, the structure stacked by the positive electrode, separator and negative electrode is immersed in the liquid electrolyte 308. In other words, the liquid electrolyte is filled within the battery 300.

According to some embodiments of the disclosure, the active layer of the positive electrode of the disclosure may be positioned between the separator 304 and the positive electrode current-collecting layer. According to embodiments of the disclosure, the active layer of the negative electrode of the disclosure may be positioned between the separator 304 and the negative electrode current-collecting layer.

According to embodiments of the disclosure, the separator 304 may include an insulating material, such as polyethylene (PE), polypropylene (PP), polytetrafluoroethylene (PTFE) film, polyamide film, polyvinyl chloride (PVC) film, polyvinylidene fluoride film, polyaniline film, polyimide film, nonwoven fabric, polyethylene terephthalate, polystyrene (PS), cellulose, or a combination thereof. For example, the separator 304 may have a multilayer composite structure such as PE/PP/PE. According to embodiments of the disclosure, the separator may have a porous structure, meaning that the pores of the separator are uniformly distributed throughout the entire separator. According to embodiments of the disclosure, the thickness of the separator is not limited and may be optionally adjusted by a person of ordinary skill in the field. For example, the thickness of the separator may be from about lum to 100 μm (such as about 5 μm, 10 μm, 15 μm, 20 μm, 25 μm, 30 μm, 40 μm, 50 μm, 60 μm, 70 μm, 80 μm, or 90 μm).

According to embodiments of the disclosure, the liquid electrolyte 308 may include a solvent and a lithium salt (or a lithium-containing compound). According to embodiments of the disclosure, the concentration of lithium salt in the solvent is from about 0.8M to 1.6M, for example, about 0.9M, 1.0M, 1.1M, 1.2M, 1.3M, 1.4M, or 1.5M. According to embodiments of the disclosure, the solvent may be an organic solvent, such as an ester solvent, ketone solvent, carbonate solvent, ether solvent, alkane solvent, amide solvent, or a combination thereof. According to embodiments of the disclosure, the solvent may be 1,2-diethoxyethane, 1,2-dimethoxyethane, 1,2-dibutoxyethane, tetrahydrofuran (THF), 2-methyl tetrahydrofuran (2-methyl THF), dimethylacetamide (DMAc), N-methyl-2-pyrrolidone (NMP), methyl acetate, ethyl acetate, methyl butyrate, ethyl butyrate, methyl propionate, ethyl propionate, propyl acetate (PA), γ-butyrolactone (GBL), ethylene carbonate (EC), propylene carbonate (PC), diethyl carbonate (DEC), ethyl methyl carbonate (EMC), dimethyl carbonate (DMC), vinylene carbonate, butylene carbonate, dipropyl carbonate, or a combination thereof. According to embodiments of the disclosure, the lithium salt may be lithium hexafluorophosphate (LiPF₆), lithium perchlorate (LiClO₄), bis(fluorosulfonyl)imide lithium (LiN(SO₂F)₂) (LiFSI), lithium difluoro (oxalato) borate (LiBF₂(C₂O₄)) (LiDFOB), lithium tetrafluoroborate (LiBF₄), lithium trifluoromethanesulfonate (LiSO₃CF₃), bis(trifluoromethane) sulfonimide lithium (LiN (SO₂CF₃)₂) (LiTFSI), lithium bis perfluoroethanesulfonimide (LiN(SO₂CF₂CF₃)₂), lithium hexafluoroarsenate (LiAsF₆), lithium Hexafluoroantimonate (LiSbF₆), lithium tetrachloroaluminate (LiAlCl₄), lithium tetrachlorogallate (LiGaCl₄), lithium nitrate (LiNO₃), tris(trifluoromethanesulfonyl)methyllithium (LiC(SO₂CF₃)₃), lithium thiocyanate hydrate (LiSCN), LiO₃SCF₂CF₃, LiC₆FsSO₃, LiO₂CCF₃, lithiumfluorosulfonate (LiSO₃F), lithium tetrakis(pentafluorophenyl) borate (LiB(C₆H₅)₄), lithium bis(oxalato) borate (LiB(C₂O₄)₂) (LiBOB), or a combination thereof.

According to embodiments of the disclosure, the battery of the disclosure may use a solid-state electrolyte instead of including a liquid electrolyte. For example, the battery of the disclosure may include a solid-state electrolyte membrane (not shown), which is placed between the positive electrode and the negative electrode. According to embodiments of the disclosure, the solid-state electrolyte may be placed on top of the separator to form a composite separator. In addition, the battery of the disclosure may use a solid-state electrolyte membrane to replace the separator.

Below, exemplary embodiments will be described in detail so as to be easily realized by a person having ordinary knowledge in the art. The inventive concept may be embodied in various forms without being limited to the exemplary embodiments set forth herein.

### Preparation of Compound Having Two Acrylate Groups

### Preparation Example 1

4-hydroxyacetophenone (1 mol), methacrylic anhydride (1.2 mol), and sodium hydrogen carbonate (sodium bicarbonate) (0.1 mol) were added to a reaction bottle. The reaction bottle was purged with nitrogen and heated to 80° C. Next, after reacting for 2 hours, 700 mL of sodium hydroxide (2 M) aqueous solution was added to the reaction bottle. After an 8-hour reaction, the result was filtered, and the collected solid was washed with water and dried to obtain Compound (1) with a yield of about 97%. The synthesis pathway of the above reaction was as follows:

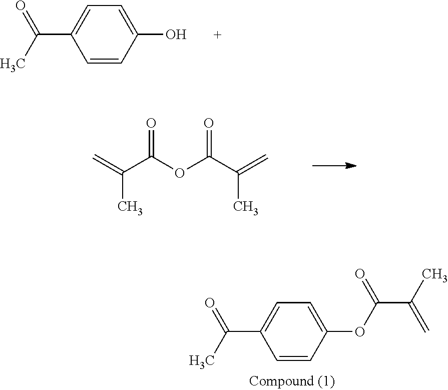

Compound (1) (0.97 mol), hydrazine sulfate (0.49 mol), triethylamine (NEt₃) (0.49 mol), and ethanol (200 g) were added to a reaction bottle. Next, the reaction bottle was heated to reflux. After reacting for 5 hours, the reaction bottle was cooled to room temperature. Once the product precipitated, the precipitate was washed with ethanol and deionized water. After drying, Compound having two acrylate groups (1) was obtained. The synthesis pathway of the above reaction was as follows:

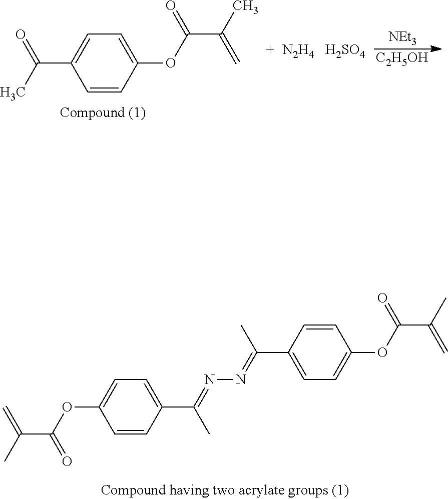 [SMILES: "C2H5OH" ; C=C(C)C(=O)Oc1ccc(C(C)=O)cc1 ; "N2H4   H2SO4" ; C=C(C)C(=O)Oc1ccc(/C(C)=N/N=C(\C)c2ccc(OC(=O)C(=C)C)cc2)cc1 ; "NEt3"]

The measurement results of nuclear magnetic resonance spectrometry of Compound having two acrylate groups (1) are shown below: 1H NMR (400 MHZ, d6-DMSO): 7.97 (d, 4H, J=8.0 Hz), 7.26 (d, 4H, J=8.0 Hz), 6.30 (s, 2H), 5.91 (s,20 2H), 2.29 (s, 6H), 2.01 (s, 6H).

### Preparation of Polymer

Preparation Example 2 95 parts by weight of ethylene-vinyl acetate copolymer (EVA) (commercially available from USI Corporation with a trade number of UE647-04, having a VA content of 28% and an MI value of 800), 5 parts by weight of Compound having two acrylate groups (1), and toluene were added to a reaction bottle. Next, the reaction bottle was heated to 105° C. After reacting for 6 hours, the solvent was removed using a rotary concentrator, yielding Polymer (1). Next, the thermal decomposition temperature (Td), melt flow rate (MFR), melting point (Tm), surface resistivity, and volume resistivity of Polymer (1) were evaluated, and the results are shown in Table 1.

The thermal decomposition temperature (Td) of the polymer of the disclosure was analyzed by a thermogravimetric analyzer (TGA). The melt flow rate (MFR) was measured by a melt flow indexer at 230° C. with a test weight of 2.16 kg, following the ASTM D 1238-A standard method. The melting point was measured by a differential scanning calorimeter (DSC) (available under the trade name Discovery DAS 25, manufactured by TA Instruments, Inc.). The surface resistivity of the polymer of the disclosure was measured by a four-point probe resistance meter (available under the trade name model DU-5211 Ohm Meter, manufactured by DELTA UNITED INSTRUMENT CO. LTD). The measurement method included the following steps. The sample was placed in the four-point probe resistance meter, and the probe was applied to the sample surface with a pressure of 0.07 MPa. After 3 seconds of contact, the resistance value (in ohms) was recorded from the instrument. The volume resistivity of the polymer of the disclosurewas determined according to IEC 62788 Jan. 2.

### Preparation Example 3

Preparation Example 3 was performed in the same manner as in Preparation Example 2, except that the weight ratio of ethylene-vinyl acetate copolymer to Compound having two acrylate groups (1) was adjusted from 95:5 to 20:80, obtaining Polymer (2). Next, the thermal decomposition temperature (Td), melt flow rate (MFR), melting point (Tm), surface resistivity, and volume resistivity of Polymer (2) were evaluated, and the results are shown in Table 1.

### Preparation Example 4

Preparation Example 4 was performed in the same manner as in Preparation Example 2, except that the weight ratio of ethylene-vinyl acetate copolymer to Compound having two acrylate groups (1) was adjusted from 95:5 to 90:10, obtaining Polymer (3). Next, the thermal decomposition temperature (Td), melt flow rate (MFR), melting point (Tm), surface resistivity, and volume resistivity of Polymer (3) were evaluated, and the results are shown in Table 1.

### Preparation Example 5

Preparation Example 5 was performed in the same manner as in Preparation Example 2, except that the weight ratio of ethylene-vinyl acetate copolymer to Compound having two acrylate groups (1) was adjusted from 95:5 to 5:95, obtaining Polymer (4). Next, the thermal decomposition temperature (Td), melt flow rate (MFR), melting point (Tm), surface resistivity, and volume resistivity of Polymer (4) were evaluated, and the results are shown in Table 1.

### Preparation Example 6

95 parts by weight of ethylene-vinyl acetate copolymer (EVA) (commercially available from USI Corporation with a trade number of UE630, having a VA content of 16% and an MI value of 1.5 g/10 min), 5 parts by weight of Compound having two acrylate groups (1), and 200 parts by weight of toluene (as a solvent) were added to a reaction bottle. Next, the reaction bottle was heated to 105° C. After reacting for 6 hours, the solvent was removed using a rotary concentrator, obtaining Polymer (5). Next, the thermal decomposition temperature (Td), melt flow rate (MFR), melting point (Tm), surface resistivity, and volume resistivity of Polymer (5) were evaluated, and the results are shown in Table 1.

### Preparation Example 7

84 g of Polymer (6) (polyvinylidene fluoride (PVDF), commercially available from Kynar with a trade number of PVDF-HVS900) was dissolved in 616 g of 1-methyl-2-pyrrolidone (NMP) to prepare a PVDF-HVS900 solution with a solid content of 12 wt %. The solution was coated onto a glass plate to form a wet film via a 200 μm gap scraper, and the wet film was then placed in an oven at 180° C. for drying to obtain a Polymer (6) film. The thermal decomposition temperature (Td), melt flow rate (MFR), melting point (Tm), surface resistivity, and volume resistivity of Polymer (6) were evaluated, and the results are shown in Table 1.

TABLE 1

| | polymer | polymer | polymer | polymer | polymer | polymer |
|---|---|---|---|---|---|---|
| | (1) | (2) | (3) | (4) | (5) | (6) |
| thermal | 342 | 360 | 350 | 355 | 345 | 375 |
| decomposition | | | | | | |
| temperature | | | | | | |
| (° C.) | | | | | | |
| melt flow rate | 1000 | 5 | 25 | 2 | 800 | 25 |
| (g/cm³) | | | | | | |
| melting point | 62 | 140 | 72 | 84 | 63 | 164 |
| (° C.) | | | | | | |
| surface | >10¹³ | >10¹⁴ | >10¹² | >10¹² | >10¹⁴ | >10¹⁴ |
| resistivity (Ω) | | | | | | |
| volume | >10¹⁴ | >10¹⁵ | >10¹³ | >10¹³ | >10¹⁵ | >10¹⁵ |
| resistivity | | | | | | |
| (Ω*cm) | | | | | | |

As shown in Table 1, the polymer of the disclosure prepared from the compound having two acrylate groups and ethylene-vinyl acetate copolymer exhibits a high thermal decomposition temperature, an appropriate melting point (which can be less than 150° C.), and a high melt flow rate.

Next, a rheometer (TA ARES-G2) was used to evaluate the rheological properties of Polymers (1) and (3)-(6) (evaluation samples with a diameter of 20 mm). The test conditions were a shear rate of 10 s-1 and a heating rate of 5.0° C./min. The results showed that Polymers (1) and (3)-(6) exhibited good melting properties.

Next, a cyclic voltammetry was used to evaluate the material activity and reaction kinetics, while simultaneously observing their stability and durability of Polymers (1) and (3). The test conditions involved a voltage range of 0 to 4.8V, wherein Polymer (1) and (3) films were introduced into a Formosa Plastics Corporation lithium iron phosphate battery. The results showed that Polymers (1) and (3) exhibited high electrochemical stability and hardly reacted with the liquid electrolyte.

### Preparation of Electrode Material

### Example 1

2,500 g of lithium iron phosphate (LFP) (commercially available from Formosa Plastics Corporation Lithium Iron Technology with a trade number of LFP-3005E) was mixed with 62.50 g of a hyperbranched polymer/ethyl cellulose resin solution (solid content: 6 wt %) (ethyl cellulose resin commercially available from Dow Chemical with a trade number of ETHOCEL STD 100) (the hyperbranched structure was synthesized by thermally polymerizing a bismaleimide monomer in N-methyl-2-pyrrolidone (NMP). During the formation of the hyperbranched polymer molecular structure, ethyl cellulose was introduced to integrate into the hyperbranched structure, forming a hybrid hyperbranched and linear interpenetrating polymer structure. The weight ratio of the hyperbranched polymer bismaleimide to ethyl cellulose resin was 2:1. This hyperbranched polymer acted as an ion-conductive additive, with an ion conductivity of 3.4×10⁻⁴ S/cm.), 178.57 g of a carbon nanotube dispersion (commercially available from Beijing Cnano Technology with a trade number of CNT-SP, served as an electron-conductive additive) (solid content: 4.2 wt %, dispersed in N-methyl-2-pyrrolidone (NMP)), 601.65 g of a polymer solution (120.33 g of polymer (1) dissolved in toluene), and 706 g of toluene to obtain Composition (1) with a solid content of 65%. In composition (1), the weight ratio of the ion-conductive additive, electron-conductive additive, and Polymer (1) was 2.85:5.70:91.45. The weight ratio of lithium iron phosphate to the total weight of the ion-conductive additive, electron-conductive additive, and Polymer (1) was 95:5. Next, Composition (1) was subjected to a spray pelletization process via a spray drying system (available under the trade name of CL-8, manufactured by Okawara Mfg. Co., Ltd.). The obtained product was collected to yield a powdered Electrode material (1). The spray pelletization process conditions were as follows: (1) Centrifugal ceramic pin atomizing disc (MC-50-8-14C) was used; (2) Inlet temperature and outlet temperature were set at 130° C. and 80° C., respectively; (3) Circulating fan frequency was 35 Hz; (4) Atomizer frequency was 40 Hz; and (5) Feed flow rate was 10.030 ml/min.

### Example 2

1,500 g of lithium iron phosphate (LFP) (commercially available from Yancheng Xincai Energy Co., Ltd. with a trade number of LFP-GF19) was mixed with 37.50 g of a hyperbranched polymer/ethyl cellulose resin solution (solid content: 6 wt %) (ethyl cellulose resin commercially available from Dow Chemical with a trade number of ETHOCEL STD 100) (the hyperbranched structure was synthesized by thermally polymerizing a bismaleimide monomer in N-methyl-2-pyrrolidone (NMP). During the formation of the hyperbranched polymer molecular structure, ethyl cellulose was introduced to integrate into the hyperbranched structure, forming a hybrid hyperbranched and linear interpenetrating polymer structure. The weight ratio of the hyperbranched polymer bismaleimide to ethyl cellulose resin was 2:1. This hyperbranched polymer acted as an ion-conductive additive, with an ion conductivity of 3.4×10⁻⁴ S/cm.), 107.14 g of a carbon nanotube dispersion (commercially available from Beijing Cnano Technology with a trade number of CNT-SP, served as an electron-conductive additive) (solid content: 4.2 wt %, dispersed in N-methyl-2-pyrrolidone (NMP)), 360.99 g of a polymer solution (120.33 g of Polymer (1) dissolved in toluene), and 424 g of toluene to obtain Composition (2) with a solid content of 65%. In composition (2), the weight ratio of the ion-conductive additive, electron-conductive additive, and Polymer (1) was 3:6:91. The weight ratio of lithium iron phosphate to the total weight of the ion-conductive additive, electron-conductive additive, and Polymer (1) was 95:5. Next, Composition (2) was subjected to a spray pelletization process via a spray drying system (available under the trade name of CL-8, manufactured by Okawara Mfg. Co., Ltd.). The obtained product was collected to yield a powdered Electrode material (2). The spray pelletization process conditions were as follows: (1) Centrifugal ceramic pin atomizing disc (MC-50-8-14C) was used; (2) Inlet temperature and outlet temperature were set at 145° C. and 110° C., respectively; (3) Circulating fan frequency was 35 Hz; (4) Atomizer frequency was 30 Hz; and (5) Feed flow rate was 12.070 ml/min.

### Example 3

1,500 g of lithium iron phosphate (LFP) (commercially available from Yancheng Xincai Energy Co., Ltd. with a trade number of LFP-GF19) was mixed with 37.47 g of a hyperbranched polymer/ethyl cellulose resin solution (solid content: 6 wt %) (ethyl cellulose resin commercially available from Dow Chemical with a trade number of ETHOCEL STD 100) (the hyperbranched structure was synthesized by thermally polymerizing a bismaleimide monomer in N-methyl-2-pyrrolidone (NMP). During the formation of the hyperbranched polymer molecular structure, ethyl cellulose was introduced to integrate into the hyperbranched structure, forming a hybrid hyperbranched and linear interpenetrating polymer structure. The weight ratio of the hyperbranched polymer bismaleimide to ethyl cellulose resin was 2:1. This hyperbranched polymer acted as an ion-conductive additive, with an ion conductivity of 3.4×10⁻⁴ S/cm.), 375.94 g of a carbon nanotube dispersion (commercially available from Beijing Cnano Technology with a trade number of CNT-SP, served as an electron-conductive additive) (solid content: 4.2 wt %, dispersed in N-methyl-2-pyrrolidone (NMP)), 607.89 g of a polymer solution (60.79 g of Polymer (3) dissolved in toluene), and 50 g of toluene to obtain Composition (3) with a solid content of 61.36%. In composition (3), the weight ratio of the ion-conductive additive, electron-conductive additive, and Polymer (3) was 3:20:77. The weight ratio of lithium iron phosphate to the total weight of the ion-conductive additive, electron-conductive additive, and Polymer (3) was 95:5. Next, Composition (3) was subjected to a spray pelletization process via a spray drying system (available under the trade name of CL-8, manufactured by Okawara Mfg. Co., Ltd.). The obtained product was collected to yield a powdered Electrode material (3). The spray pelletization process conditions were as follows: (1) Centrifugal ceramic pin atomizing disc (MC-50-8-14C) was used; (2) Inlet temperature and outlet temperature were set at 145° C. and 110° C., respectively; (3) Circulating fan frequency was 50 Hz; (4) Atomizer frequency was 30 Hz; and (5) Feed flow rate was 12.070 ml/min.

### Example 4

2,000 g of lithium iron phosphate (LFP) (commercially available from Yancheng Xincai Energy Co., Ltd. with a trade number of LFP-GF19) was mixed with 106.38 g of a hyperbranched polymer/ethyl cellulose resin solution (solid content: 6 wt %) (ethyl cellulose resin commercially available from Dow Chemical with a trade number of ETHOCEL STD 100) (the hyperbranched structure was synthesized by thermally polymerizing a bismaleimide monomer in N-methyl-2-pyrrolidone (NMP). During the formation of the hyperbranched polymer molecular structure, ethyl cellulose was introduced to integrate into the hyperbranched structure, forming a hybrid hyperbranched and linear interpenetrating polymer structure. The weight ratio of the hyperbranched polymer bismaleimide to ethyl cellulose resin was 2:1. This hyperbranched polymer acted as an ion-conductive additive, with an ion conductivity of 3.4×10⁻⁴ S/cm.), 506.59 g of a carbon nanotube dispersion (commercially available from Beijing Cnano Technology with a trade number of CNT-SP, served as an electron-conductive additive) (solid content: 4.2 wt %, dispersed in N-methyl-2-pyrrolidone (NMP)), 666.67 g of a polymer solution (100.00 g of Polymer (3) dissolved in toluene), and 975.68 g of N-methyl-2-pyrrolidone (NMP) to obtain Composition (4) with a solid content of 61.36%. In composition (4), the weight ratio of the ion-conductive additive, electron-conductive additive, and Polymer (3) was 5:16.67:78.33. The weight ratio of lithium iron phosphate to the total weight of the ion-conductive additive, electron-conductive additive, and Polymer (3) was 94:6. Next, Composition (4) was subjected to a spray pelletization process via a spray drying system (available under the trade name of CL-8, manufactured by Okawara Mfg. Co., Ltd.). The obtained product was collected to yield a powdered Electrode material (4). The spray pelletization process conditions were as follows: (1) Centrifugal ceramic pin atomizing disc (MC-50-8-14C) was used; (2) Inlet temperature and outlet temperature were set at 140° C. and 120° C., respectively; (3) Circulating fan frequency was 45 Hz; (4) Atomizer frequency was 25 Hz; and (5) Feed flow rate was 5.160 ml/min.

### Example 5

1,800 g of lithium iron phosphate (LFP) (commercially available from Yancheng Xincai Energy Co., Ltd. with a trade number of LFP-GF19) was mixed with 157.89 g of a hyperbranched polymer/ethyl cellulose resin solution (solid content: 6 wt %) (ethyl cellulose resin commercially available from Dow Chemical with a trade number of ETHOCEL STD 100) (the hyperbranched structure was synthesized by thermally polymerizing a bismaleimide monomer in N-methyl-2-pyrrolidone (NMP). During the formation of the hyperbranched polymer molecular structure, ethyl cellulose was introduced to integrate into the hyperbranched structure, forming a hybrid hyperbranched and linear interpenetrating polymer structure. The weight ratio of the hyperbranched polymer bismaleimide to ethyl cellulose resin was 2:1. This hyperbranched polymer acted as an ion-conductive additive, with an ion conductivity of 3.4×10⁻⁴ S/cm.), 451.13 g of a carbon nanotube dispersion (commercially available from Beijing Cnano Technology with a trade number of CNT-SP, served as an electron-conductive additive) (solid content: 4.2 wt %, dispersed in N-methyl-2-pyrrolidone (NMP)), 442.11 g of a polymer solution (100.00 g of Polymer (3) dissolved in toluene), and 306.77 g of N-methyl-2-pyrrolidone (NMP) to obtain Composition (5) with a solid content of 60.00%. In composition (5), the weight ratio of the ion-conductive additive, electron-conductive additive, and Polymer (3) was 1:2:7. The weight ratio of lithium iron phosphate to the total weight of the ion-conductive additive, electron-conductive additive, and Polymer (3) was 95:5. Next, Composition (5) was subjected to a spray pelletization process via a spray drying system (available under the trade name of CL-8, manufactured by Okawara Mfg. Co., Ltd.). The obtained product was collected to yield a powdered Electrode material (5). The spray pelletization process conditions were as follows: (1) Centrifugal ceramic pin atomizing disc (MC-50-8-14C) was used; (2) Inlet temperature and outlet temperature were set at 110° C. and 70° C., respectively; (3) Circulating fan frequency was 45 Hz; (4) Atomizer frequency was 25 Hz; and (5) Feed flow rate was 10.030 ml/min.

### Example 6

6,000 g of lithium iron phosphate (LFP) (commercially available from ALL RING TECH CO., LTD. with a trade number of LFP-A8-4E) was mixed with 64.17 g of graphite (with a trade number of KS6, commercially available from TIMCAL Taiwan Boly Co., Ltd., used as an electron-conductive additive), 160.435 g of conductive carbon black (with a trade number of Super-P, commercially available from Taiwan Boly Co., Ltd., used as an electron-conductive additive), and 192.51 g of Polymer (3) to Composition (6). The composition (6) was then subjected to a melt blending process using an internal mixer (manufactured by Li—Na Machinery Industrial Co., Ltd., model KD-3-7.5) at a temperature of 120° C. for 1 hour, resulting in a Powdered electrode material (6). In Composition (6), the weight ratio of KS6, Super-P, and Polymer (3) was 2:5:6; and the weight ratio of lithium iron phosphate to the total weight of the electron-conductive additive and Polymer (3) was 93.5:6.5.

### Example 7

1,800 g of lithium iron phosphate (LFP) (commercially available from ALL RING TECH CO., LTD. with a trade number of LFP-A⁸-4E), 19.25 g of graphite (commercially available from Taiwan Boly Co., Ltd. with a trade number of KS6, served as an electron-conductive additive), 48.13 g of conductive carbon black (commercially available from Taiwan Boly Co., Ltd. with a trade number of Super-P, served as an electron-conductive additive), 57.75 g of Polymer (5), and 1,036.61 g of toluene were mixed to obtain Composition (7) (solid content: 65.00%). In composition (7), the weight ratio of KS6, Super-P, and Polymer (5) was 1:2.5:3; and the weight ratio of lithium iron phosphate to the total weight of KS6, Super-P, and Polymer (5) was 93.5:6.5. Next, Composition (7) was subjected to a spray pelletization process via a spray drying system (available under the trade name of CL-8, manufactured by Okawara Mfg. Co., Ltd.). The obtained product was collected to yield a powdered Electrode material (7). The spray pelletization process conditions were as follows: (1) Centrifugal ceramic pin atomizing disc (MC-50-8-14C) was used; (2) Inlet temperature and outlet temperature were set at 120° C. and 70° C., respectively; (3) Circulating fan frequency was 35 Hz; (4) Atomizer frequency was 35 Hz; and (5) Feed flow rate was 50.150 ml/min.

### Example 8

1,800 g of lithium iron phosphate (LFP) (commercially available from ALL RING TECH CO., LTD. with a trade number of LFP-A⁸-4E), 19.25 g of graphite (commercially available from Taiwan Boly Co., Ltd. with a trade number of KS6, served as an electron-conductive additive), 48.13 g of conductive carbon black (commercially available from Taiwan Boly Co., Ltd. with a trade number of Super-P, served as an electron-conductive additive), 28.9 g of Polymer (3), 28.9 g of Polymer (5) and 1,036.61 g of toluene were mixed to obtain Composition (8) (solid content: 65.00%). In composition (8), the weight ratio of KS6, Super-P, Polymer (3) and Polymer (5) was 1:2.5:1.5:1.5; and the weight ratio of lithium iron phosphate to the total weight of KS6, Super-P, Polymer (3) and Polymer (5) was 93.5:6.5. Next, Composition (8) was subjected to a spray pelletization process via a spray drying system (available under the trade name of CL-8, manufactured by Okawara Mfg. Co., Ltd.). The obtained product was collected to yield a powdered Electrode material (8). The spray pelletization process conditions were as follows: (1) Centrifugal ceramic pin atomizing disc (MC-50-8-14C) was used; (2) Inlet temperature and outlet temperature were set at 120° C. and 70° C., respectively; (3) Circulating fan frequency was 35 Hz; (4) Atomizer frequency was 35 Hz; and (5) Feed flow rate was 25.160 ml/min.

Herein, as an example, the morphology of Electrode material (1) is evaluated as follows. The particle size distribution, powder tapped density, and BET specific surface area of lithium iron (i.e., active particles) used to prepare Electrode material (1) and Electrode material (1) are evaluated, and the results are shown in Table 2. The particle size distribution is determined according to ISO 13322-1:2004; the specific surface area measurement can be conducted using a specific surface area instrument (Micromeritics Instrument Corporation ASAP2400); and the powder tapped density is measured by a tapped density tester according to the method specified in ISO 3953.

TABLE 2

| | | | | tapped | specific |
|---|---|---|---|---|---|
| | particle size distribution (μm) | | | density | surface |
| | D10 | D50 | D90 | (g/cm³) | area (m²/g) |
| lithium iron | 1.02 | 3.9 | 14.65 | 1.04 | 9.38 |
| phosphate | | | | | |
| Electrode | 1.1 | 5.11 | 16.33 | 1.22 | 8.35 |
| material (1) | | | | | |
| lithium- | 3.116 | 6.297 | 13.854 | 0.48 | 0.83 |
| nickel- | | | | | |
| cobalt- | | | | | |
| aluminum | | | | | |
| oxide ternary | | | | | |
| material | | | | | |
| (NMC) | | | | | |
| surface- | 3.117 | 6.060 | 12.521 | 0.54 | 0.76 |
| coated | | | | | |
| modified | | | | | |
| electrode | | | | | |
| material | | | | | |

The original lithium iron phosphate has a relatively broad overall particle size distribution. After modification, smaller particles agglomerate into spherical shapes during the spray-drying process, resulting in a decrease in specific surface area. Therefore, Electrode material (1) of the disclosure has improved particle size, uniformity in particle size distribution, and increased tapped density, which is beneficial for increasing the density of the active layer during the subsequent thermocompression process. Additionally, after modification, the specific surface area of Electrode material (1) decreases, indicating that Electrode material (1) adopts a more spherical shape. Furthermore, after the above-mentioned surface modification and spray pelletization of lithium-nickel-cobalt-aluminum oxide ternary positive electrode material (NMC/Geos Technology Co.), similar results can be obtained. Smaller and larger structures are reduced (e.g., the proportion of particles smaller than 1 μm decreases from 0.5% to 0%, and the proportion of particles larger than 25 μm decreases from 3.5% to 1.6%), with a more uniform structure size (e.g., the proportion of particles between 1-25 μm increases from 96.0% to 98.4%). The powder particles tend to a more spherical structure, which is beneficial for improving the density of the active layer during the subsequent thermocompression process, as shown in Table 2.

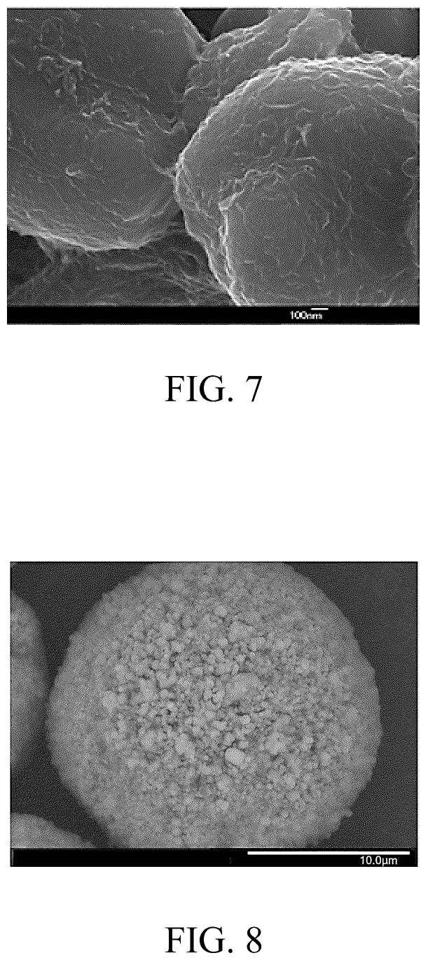

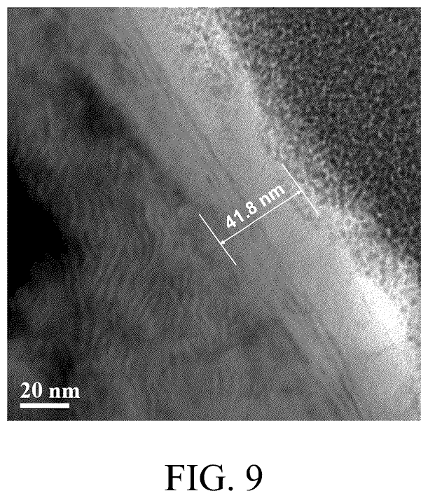

Next, Electrode materials (1) and (8) are observed by a scanning electron microscope (SEM), and the results are shown in FIGS. 7 and 8, respectively. As seen in FIGS. 7 and 8, Electrode material (1) consists of spherical particles, with a more uniform particle size distribution, and no particles larger than 30 μm are observed. Next, Electrode material (1) was observed by a focused ion beam (FIB) transmission electron microscope (TEM), and the results are shown in FIG. 9. As shown in FIG. 9, the cladding layer of Electrode material (1) has a thickness of about 40 nm to 60 nm. Accordingly, the electrode material of the disclosure may have spherical particles with a core-shell structure.

### Comparative Example 1

1,800 g of lithium iron phosphate (LFP) (commercially available from ALL RING TECH CO., LTD. with a trade number of LFP-A⁸-4E), 19.25 g of graphite (commercially available from Taiwan Boy Co., Ltd. with a trade number of KS6, served as an electron-conductive additive), 48.13 g of conductive carbon black (commercially available from Taiwan Boly Co., Ltd. with a trade number of Super-P, served as an electron-conductive additive), 57.75 g of Polymer (6), and 1,036.61 g of toluene were mixed to obtain Composition (9) (solid content: 65.00%). In composition (9), the weight ratio of the electron-conductive additive to Oolymer (6) is 7:6; and the weight ratio of lithium iron phosphate to the total weight of the ion-conductive additive and Polymer (6) is 93.5:6.5. Next, Composition (9) was subjected to a spray pelletization process via a spray drying system (available under the trade name of CL-8, manufactured by Okawara Mfg. Co., Ltd.). The obtained product was collected to yield a powdered Electrode material (9). The spray pelletization process conditions were as follows: (1) Centrifugal ceramic pin atomizing disc (MC-50-8-14C) was used; (2) Inlet temperature and outlet temperature were set at 1350° C. and 100° C., respectively; (3) Circulating fan frequency was 40 Hz; (4) Atomizer frequency was 45 Hz; and (5) Feed flow rate was 10.303 ml/min.

### Process of Dry Electrode Film

### Example 9

Method I: A benchtop tablet press (Retsch PP35, pressure 35 tons) system was used, and Electrode material (1) was placed into a 40 mm tablet mold set (with an automatic ejection function) for dry pressing of the electrode composition powder at room temperature. The pressure was increased from 5 tons to 25 tons. After ejection, Dry electrode film (1-I) was obtained. The weight (cut to a 3 cm×3 cm area), thickness, electrode active material loading, and electrode material compacted density of Dry electrode film (1-I) are shown in Table 3.

Method II: Electrode material (1) was added to a small extruder with a modified homogeneous feeding module for preheating and uniform mixing. The material was quantitatively fed through a transfer screw (with preheat temperatures of 90° C. in the front, middle, and rear sections of the screw pipeline), a screw speed of 1100 rpm, and an extrusion rate of 46.8 kg/hr. After uniform and metered extrusion, the powder was transmitted through a flat die head (with a width of up to 145 mm) into a hot rolling module system (with a nip pressure control value of 200 N/mm and roller heating temperatures of 90° C.) to prepare Dry electrode film (1-II). The weight (cut to a 3 cm×3 cm area), thickness, electrode active material loading, and electrode material compacted density of Dry electrode film (1-II) are shown in Table 3.

Method II was Repeated with Modifications to the Process Parameters as Shown in Table 3, Resulting in Dry Electrode Film (1-III).

### Examples 10⁻¹⁶

Examples 10⁻¹⁶ were performed in the same manner as in Example 9, except that Electrode materials (2)-(8) were used instead of Electrode material (1), with process parameters modified according to Table 3 to obtain Dry electrode films (2-I) to (8-II). The weight, thickness, electrode active material loading, and electrode material compacted density of Dry electrode films (2-I) to (8-II) are shown in Table 3.

### Comparative Example 2

Comparative Example 2 was performed in the same manner as in Example 9, except that Electrode material (9) (Comparative Example 1) was used instead of Electrode material (1), with process parameters modified according to Table 3 to obtain Dry electrode films (9-1) and (9-II). The weight, thickness, electrode active material loading, and electrode material compacted density of Dry electrode films (9-1) and (9-II) are shown in Table 3.

### Comparative Example 3

The preparation method of a wet-processed positive electrode plate was disclosed as following. Lithium iron phosphate active material, Super P electron-conductive additive, KS-6 electron-conductive additive, and an appropriate amount of solvent (such as 1-methyl-2-pyrrolidone, NMP) were mixed and stirred for 3 hours. A solution containing PVDF-HSV900 binder in NMP (containing 10 wt % PVDF) was then added and stirred for another 3 hours to obtain a lithium iron phosphate positive electrode slurry with a solid content of 65 wt %. The solid components of the composition included lithium iron phosphate active material (93.5 wt %), PVDF-HSV900 binder (3 wt %), Super P electron-conductive additive (2.5 wt %), and KS-6 electron-conductive additive (1 wt %). The positive electrode slurry was coated onto a current-collecting substrate (such as an aluminum metal foil), heated to 150° C. for drying, and rolled to form a 100 μm-thick positive electrode active layer on the metal foil, obtaining Electrode film (10).

Electrode film (10) was then transferred into a hot rolling module system (with a nip pressure control value of 200 N/mm and roller heating temperatures of 90° C.) to prepare Electrode film (11). The weight (cut to a 3 cm×3 cm area), thickness, electrode active material loading, and electrode material compacted density of Electrode films (10) and (11) are shown in Table 3.

TABLE 3

| | pressing | preheat | roller | main roller | weight of | thickness of | mass | compacted |
|---|---|---|---|---|---|---|---|---|
| | Force | Temperature | Temperature | speed | electrode | electrode | loading | density |
| | (tons) | (° C.) | (° C.) | (m/min) | film (mg) | film (μm) | (g/cm²) | (mg/cm³) |
| Electrode | 25 | — | — | — | 400 | 138 | 30.2 | 2.30 |
| film (1-I) | | | | | | | | |
| Electrode | — | 90 | 90 | 5 | 451 | 262 | 47.6 | 1.91 |
| film (1-II) | | | | | | | | |
| Electrode | — | 110 | 100 | 1 | 387 | 192 | 40.9 | 2.24 |
| film (1- | | | | | | | | |
| III) | | | | | | | | |
| Electrode | 25 | — | — | — | 400 | 256 | 30.3 | 2.18 |
| film (2-I) | | | | | | | | |
| Electrode | — | 90 | 80 | 5 | 574 | 329 | 57.4 | 1.94 |
| film (2-II) | | | | | | | | |
| Electrode | 25 | — | — | — | 400 | 138 | 30.3 | 2.31 |
| film (3-I) | | | | | | | | |
| Electrode | — | 120 | 110 | 1 | 455 | 227 | 32.3 | 2.23 |
| film (3-II) | | | | | | | | |
| Electrode | 25 | — | — | — | 400 | 144 | 29.9 | 2.21 |
| film (4-1) | | | | | | | | |
| Electrode | — | 120 | 110 | 1 | 371 | 176 | 38.8 | 2.34 |
| film (4-/II) | | | | | | | | |
| Electrode | 25 | — | — | — | 500 | 172 | 37.8 | 2.31 |
| film (5-I) | | | | | | | | |
| Electrode | — | 130 | 120 | 1 | 286 | 142 | 30.24 | 2.24 |
| film (5-II) | | | | | | | | |
| Electrode | 35 | — | — | — | 500 | 182 | 42.33 | 2.49 |
| film (6-I) | | | | | | | | |
| Electrode | — | 120 | 110 | 1 | 438 | 201 | 45.5 | 2.42 |
| film (6-II) | | | | | | | | |
| Electrode | 25 | — | — | — | 500 | 167 | 37.2 | 2.38 |
| film (7-I) | | | | | | | | |
| Electrode | 30 | — | — | — | 500 | 164 | 37.2 | 2.42 |
| film (7-I) | | | | | | | | |
| Electrode | 35 | — | — | — | 500 | 160 | 37.2 | 2.48 |
| film (7-I) | | | | | | | | |
| Electrode | — | 120 | 110 | 2 | 428 | 204 | 44.5 | 2.33 |
| film (7-II) | | | | | | | | |
| Electrode | — | 110 | 100 | 2 | 384 | 186 | 39.9 | 2.29 |
| film (7-II) | | | | | | | | |
| Electrode | 35 | — | — | — | 500 | 164 | 37.2 | 2.43 |
| film (8-I) | | | | | | | | |
| Electrode | — | 120 | 120 | 2 | 282 | 133 | 29.3 | 2.35 |
| film (8-II) | | | | | | | | |
| Electrode | 25 | — | — | — | 500 | The structure was brittle and | | |
| film (9-I) | | | | | | cannot form a complete film for | | |
| | | | | | | measurement. | | |
| Electrode | — | 150 | 130 | 1 | 525 | 249 | 54.54 | 2.34 |
| film (9-II) | | | | | | | | |

| | | | | |
|---|---|---|---|---|
| Electrode film (10) | 207 | 124 | 21.5 | 1.85 |
| Electrode film (11) | 207 | 100 | 21.5 | 2.30 |

As shown in Table 3, in conventional wet processes, since it is necessary to completely evaporate the NMP solvent without residue, the lithium iron phosphate active material mass loading of the electrode film is typically between 15-25 mg/cm² and rarely exceeds 25 mg/cm². As a result, capacity is difficult to significantly increase. Excessive active material mass loading increases the electrode film thickness, thereby making it difficult to fully evaporate the solvent, leading to residual solvent. Moreover, excessive solvent may cause instability in the negative electrode material structure, negatively impacting subsequent electrode and battery performance, especially by reducing capacity and life cycle. In addition, during solvent evaporation, the binder often forms a gradient-layer distribution within the electrode structure, which affects the structural stability, adhesion strength, and cycling performance of the electrode film. Furthermore, electrode films produced through coating and drying processes tend to have a loose structure with poor adhesion properties. In order to improve structural compactness and adhesion strength, a high-pressure roller compaction is required. However, excessive roller pressure may embed the active material (which has high hardness) too deeply into the relatively soft aluminum foil structure, causing strain-induced tearing or fractures in the aluminum foil. This would lead to cracks or breakage in the electrode film. Therefore, the compacted density of lithium iron phosphate electrode films is typically controlled between 2.3-2.5 g/cm³ and rarely exceeds 2.5 g/cm³. By means of the electrode material composition of the disclosure, dry electrode films may be directly produced through thermal roller pressing without requiring wet coating and drying processes. This significantly reduces solvent usage and VOC emissions, providing an environmentally friendly manufacturing approach. From the test and measurement results of the electrode composition in Table 3, it is evident that the dry electrode films produced via Method I or Method II exhibit structural flexibility and adhesion properties, allowing them to withstand high roller pressure and high shear forces. Therefore, when increasing the film thickness (e.g., above 150 μm), the dry electrode films are less likely to develop rigid cracks or bending fractures. Therefore, the electrode films produced according to the disclosure can achieve an adjustable active material mass loading of over 30 mg/cm² (even exceeding 45 mg/cm²). Additionally, before bonding with the aluminum foil and undergoing roller pressing, the initial compacted density of the electrode film can be adjusted to exceed 2.2 g/cm³ (even surpassing 2.4 g/cm³). A higher initial compacted density enhances structural stability, reduces expansion and deformation, and improves the storage durability and processability of the electrode film.

### Single-Sided Dry Electrode

The previously prepared electrode films (1-II), (2-II), (3-II), (4-II), (5-II), (6-II), (7-II), (8-II), (9-II), and electrode film (11) were further processed using a rolling press machine (commercially available from TOKYO, model: ONO 2RM-350DRR) for lamination and compaction onto an aluminum foil substrate (commercially available from BLUEGLOWNANO, thickness: 12 μm). The rolling pressure (0-30 kgf/cm²) and rolling speed (1 m/min) were adjusted accordingly to obtain compacted single-sided Dry electrodes (1) to (9) and Electrode (10). The corresponding compacted densities of these electrodes are shown in Table 4.

### Peeling Strength

The peeling strength between the current-collecting layer and the active layer of Dry electrodes (1) to (9) and Electrode (10) was measured, with the results shown in Table 4. The peeling strength test was conducted using a universal tensile machine (commercially available from Shimadzu, model: AG-X PLIS) based on the ASTM D903-98 180-degree peeling strength test standard. The compacted single-sided dry electrode sheets were cut into rectangular strips measuring 120 mm×25 mm to prepare test samples. A strip of insulating tape (18 mm×35 mm) was attached to the top end of a stainless steel plate, and a 30 mm×100 mm double-sided adhesive tape was affixed to the stainless steel plate over the insulating tape. The other side of the double-sided tape was adhered to the active layer surface of the single-sided dry electrode sheet. Additionally, a 30 mm×30 mm rectangular strip of double-sided adhesive backing paper was placed underneath the electrode sheet, while a 30 mm×50 mm strip was attached to the top surface of the electrode sheet. A 2 kg roller was used to press over the backing paper of the electrode twice. The free end of the electrode sheet was then fixed onto the upper grip of the tensile testing machine, while the bottom end of the stainless steel plate was secured to the lower grip. The test parameters were set with a peeling length of 40 mm, a width of 18 mm, and a peeling speed of 50 mm/min. The 180-degree peeling strength test was performed, and the results are shown in Table 4.

TABLE 4

| | | | compacted | |
|---|---|---|---|---|
| | | roll press | density of | peeling |
| | | pressure | electrode | strength |
| | electrode material | (Kgf/cm²) | film (g/cm³) | (N/m) |
| Electrode (1) | Electrode material | 10 | 2.42 | 123 |
| | (1) | | | |
| Electrode (2) | Electrode material | 10 | 2.37 | 96 |
| | (2) | | | |
| Electrode (3) | Electrode material | 10 | 2.39 | 122 |
| | (3) | | | |
| Electrode (4) | Electrode material | 10 | 2.41 | 166 |
| | (4) | | | |
| Electrode (5) | Electrode material | 10 | 2.47 | 232 |
| | (5) | | | |
| Electrode (6) | Electrode material | 10 | 2.55 | 331 |
| | (6) | | | |
| Electrode (7) | Electrode material | 10 | 2.50 | 234 |
| | (7) | | | |
| Electrode (8) | Electrode material | 10 | 2.46 | 235 |
| | (8) | | | |
| Electrode (10) | Electrode material | 10 | 2.30 | 62 |
| | (10) | | | |

Electrode films with higher compaction density offer multiple benefits, particularly in battery technology, including improved energy density, enhanced conductivity (lower internal resistance), improved charge-discharge performance, better structural stability, longer lifecycle, reduced battery expansion and deformation (enhancing safety), and improved thermal conductivity (enhancing thermal management performance). As shown in Table 4, the compacted density of dry Electrodes (1) to (8) in the Examples exceeds 2.35 g/cm³ (even reaching above 2.50 g/cm³), providing more advantages compared to wet-process electrodes.

Peeling strength is a crucial indicator of electrode stability and reliability in battery applications, reflecting the bonding strength between electrode composite materials and metal foils. Insufficient peeling strength may lead to electrode delamination and interrupted current transmission during battery operation. Higher peeling strength ensures better battery performance, extended lifecycle, and enhanced safety. As shown in Table 4, at comparable compacted density (e.g., 2.3-2.4 g/cm³), dry electrodes exhibit greater peeling strength than wet-process electrodes. Additionally, as electrode compaction density increases, peeling strength also improves accordingly.

Evaluation of Performance of electrode Using Half-Cell Testing

### Example 17

Electrode (4) was provided to serve as the positive electrode, a polypropylene (PP) separator (commercially available from Celgard with a trade number of 2320, having a thickness of about 20 μm) was provided, and a liquid electrolyte used in lithium iron phosphate battery (Formosa Plastics Corporation, model: LE) was provided. Lithium metal served as the negative electrode.

Next, the battery assembly followed the sequence of negative electrode/separator/positive electrode (with the active layer of the positive electrode facing the separator). The liquid electrolyte (commercially available from Formosa Plastics Corporation with a trade number of FPC-401) was injected between the positive and negative electrodes to ensure the separator was fully immersed. A CR2032 coin cell (dimensions: 3.2 mm (thickness)×20 mm (width)×20 mm (length)) was assembling to obtain Coin battery (1). The cell was stood for one day to allow the liquid electrolyte to diffuse and fully soak the electrodes. Subsequently, Coin battery (1) was placed into a MACCOR SERIES 4000 charge-discharge tester. The cell was charged with 0.1C to 3.75V and discharged with 0.1C to 2.5V (cut-off: 0.01C), with three charge-discharge cycles conducted for formation. The electrical performance of Coin battery (1) was measured and recorded, as shown in Table 5.

### Example 18

Electrode (7) was provided to serve as the positive electrode, a polypropylene PP separator (commercially available from Celgard with a trade number of 2320, having a thickness of about 20 μm) was provided, and a liquid electrolyte used in lithium iron phosphate battery (Formosa Plastics Corporation, model: LE) was provided. Lithium metal was used as the negative electrode.

Next, the battery assembly followed the sequence of negative electrode/separator/positive electrode (with the active layer of the positive electrode facing the separator). The liquid electrolyte (commercially available from Formosa Plastics Corporation with a trade number of FPC-401) was injected between the positive and negative electrodes to ensure the separator was fully immersed. A CR2032 coin cell (dimensions: 3.2 mm (thickness)×20 mm (width)×20 mm (length)) was assembling to obtain Coin battery (2). The cell was stood for one day to allow the liquid electrolyte to diffuse and fully soak the electrodes. Subsequently, Coin battery (2) was placed into a MACCOR SERIES 4000 charge-discharge tester. The cell was charged with 0.1C to 3.75V and discharged with 0.1C to 2.5V (cut-off: 0.01C), with three charge-discharge cycles conducted for formation. The electrical performance of Coin battery (2) was measured and recorded, as shown in Table 5.

### Comparative Example 4

Electrode (9) was provided to serve as the positive electrode, a polypropylene PP separator (commercially available from Celgard with a trade number of 2320, having a thickness of about 20 μm) was provided, and a liquid electrolyte used in lithium iron phosphate battery (Formosa Plastics Corporation, model: LE) was provided. Lithium metal was used as the negative electrode.

Next, the battery assembly followed the sequence of negative electrode/separator/positive electrode (with the active layer of the positive electrode facing the separator). The liquid electrolyte (commercially available from Formosa Plastics Corporation with a trade number of FPC-401) was injected between the positive and negative electrodes to ensure the separator was fully immersed. A CR2032 coin cell (dimensions: 3.2 mm (thickness)×20 mm (width)×20 mm (length)) was assembling to obtain Coin battery (3). The cell was stood for one day to allow the liquid electrolyte to diffuse and fully soak the electrodes. Subsequently, Coin battery (3) was placed into a MACCOR SERIES 4000 charge-discharge tester. The cell was charged with 0.1C to 3.75V and discharged with 0.1C to 2.5V (cut-off: 0.01C), with three charge-discharge cycles conducted for formation. The electrical performance of Coin battery (3) was measured and recorded, as shown in Table 5.

### Comparative Example 5

Electrode (10) was provided to serve as the positive electrode, a polypropylene PP separator (commercially available from Celgard with a trade number of 2320, having a thickness of about 20 μm) was provided, and a liquid electrolyte used in lithium iron phosphate battery (Formosa Plastics Corporation, model: LE) was provided. Lithium metal was used as the negative electrode.

Next, the battery assembly followed the sequence of negative electrode/separator/positive electrode (with the active layer of the positive electrode facing the separator). The liquid electrolyte (commercially available from Formosa Plastics Corporation with a trade number of FPC-401) was injected between the positive and negative electrodes to ensure the separator was fully immersed. A CR2032 coin cell (dimensions: 3.2 mm (thickness)×20 mm (width)×20 mm (length)) was assembling to obtain Coin battery (4). The cell was stood for one day to allow the liquid electrolyte to diffuse and fully soak the electrodes. Subsequently, Coin battery (4) was placed into a MACCOR SERIES 4000 charge-discharge tester. The cell was charged with 0.1C to 3.75V and discharged with 0.1C to 2.5V (cut-off: 0.01C), with three charge-discharge cycles conducted for formation. The electrical performance of Coin battery (4) was measured and recorded, as shown in Table 5.

TABLE 5

| | | Coin | Coin | Coin | Coin |
|---|---|---|---|---|---|
| | | battery | battery | battery | battery |
| | | (1) | (2) | (3) | (4) |
| active material weight | | 13 | 39.9 | 52.5 | 25.8 |
| of electrode (g) | | | | | |
| compacted density (g/cm³) | | 2.35 | 2.3 | 2.31 | 2.31 |
| first charge- | charging specific | 148.02 | 156.3 | 162.4 | 168.6 |
| discharge | capacity (mAh/g) | | | | |
| cycle | discharging | 141 | 148.8 | 164.3 | 162.2 |
| | specific capacity | | | | |
| | (mAh/g) | | | | |
| | Coulombic | 95.3 | 95.2 | 101 | 96.2 |
| | efficiency (%) | | | | |
| second | charging specific | 141.07 | 150.2 | 164.2 | 161.4 |
| charge- | capacity (mAh/g) | | | | |
| discharge | discharging | 142.1 | 157.7 | 164 | 163.5 |
| cycle | specific capacity | | | | |
| | (mAh/g) | | | | |
| | irreversible | −1 | −5 | 0 | −1 |
| | capacity (%) | | | | |
| third charge- | charging specific | 142.42 | 157.1 | 164.2 | 163.7 |
| discharge | capacity (mAh/g) | | | | |
| cycle | discharging | 142.4 | 159.6 | 164.3 | 164.6 |
| | specific capacity | | | | |
| | (mAh/g) | | | | |
| | irreversible | 0 | −2 | 0 | −1 |
| | capacity (%) | | | | |
| formation | internal | 7.2 | 7.4 | 7.4 | 21.7 |
| completed | resistance (W) | | | | |
| | voltage (V) | 3.429 | 3.587 | 3.565 | 3.418 |

As shown in Table 5, the resistance of the half-cell prepared using the dry-process electrode of the disclosure was about 702-902 after formation. In contrast, the battery using a wet-process electrode exhibited a resistance of about 2152-2352. The dry-process electrode offers lower resistance, which enhances energy efficiency, improves battery performance, extends battery lifespan, increases stability and safety, and enhances discharge stability.

Accordingly, due to the electrode material with a specific structure and composition as disclosed, the electrode material can be processed (such as in a dry electrode process) to form the active layer on the surface of the current-collecting layer at a relatively low operating temperature. As a result, the formed active layer not only has improved mechanical strength and good adhesion, but also enhances the mass loading, compacted density, and stability of the active layer, thereby improving the charge and discharge capacity, energy density of the battery, and significantly reducing internal resistance of the battery. As a result, this leads to higher energy efficiency, enhanced battery performance, extended battery life, improved stability and safety, and better discharge stability.

It will be clear that various modifications and variations may be made to the disclosed methods and materials. It is intended that the specification and examples be considered as exemplary only, with the true scope of the disclosure being indicated by the following claims and their equivalents.

What is claimed is:

1. An electrode material, comprising:
an active particle; and
a cladding layer partially or completely covering the surface of the active particle, wherein the cladding layer comprises:
5 to 70 parts by weight of a conductive additive; and
30 to 95 parts by weight of a first polymer, wherein the total weight of the first polymer and the conductive additive is 100 parts by weight, wherein the first polymer is a product of a compound having two acrylate groups and an ethylene-vinyl acetate copolymer via a polymerization, wherein the compound having two acrylate groups has a structure represented by Formula (I) 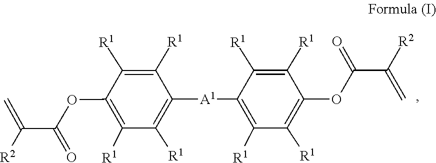
wherein A¹ is single bond, oxygen, 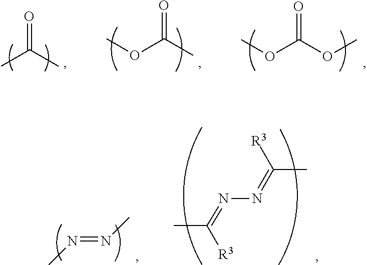
or —CH═CH—; each R¹ are independently hydrogen or methyl; each R² are independently hydrogen or methyl; and, each R³ are independently hydrogen, methyl or ethyl.

2. The electrode material as claimed in claim 1, wherein a weight ratio of the compound having two acrylate groups to the ethylene-vinyl acetate copolymer is from 1:99 to 99:1.

3. The electrode material as claimed in claim 1, wherein the ethylene-vinyl acetate copolymer has a repeating unit having a structure of Formula (II) and a repeating unit having the structure of Formula (III) 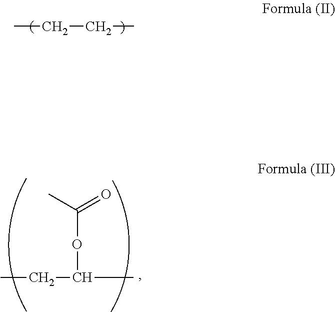
wherein a number ratio of the repeating unit having the structure of Formula (II) to the repeating unit having the structure of Formula (III) is from 1:1250 to 300:1.

4. The electrode material as claimed in claim 1, wherein the cladding layer further comprises:
0.1 to 30 parts by weight of a second polymer, wherein the second polymer is polyamide, polyimide, polymaleimide, polybismaleimide, polyacrylate, polyacrylic acid, polyvinyl alcohol, sodium carboxymethyl cellulose, polystyrene, styrene-butadiene rubber, polyurethane, polyethylene-based polyvinylpyrrolidone, polyvinyl chloride, polyacrylonitrile, polybutadiene, or combinations thereof.

5. The electrode material as claimed in claim 1, wherein the active particle is a positive electrode active material or negative electrode active material.

6. The electrode material as claimed in claim 1, wherein the conductive additive is an electron-conductive additive, ion-conductive additive or a combination thereof.

7. The electrode material as claimed in claim 1, wherein the active particle has a particle size of from 50 nm to 100 μm.

8. The electrode material as claimed in claim 1, wherein the cladding layer has a thickness of from 10 nm to 5 μm.

9. The electrode material as claimed in claim 1, wherein a weight ratio of the cladding layer to the active particle is from 3:97 to 10:90.

10. The electrode material as claimed in claim 1, wherein the electrode material has a core-shell structure consisting of a core and a shell layer encapsulating the core, wherein the core is the active particle, and the shell layer is the cladding layer.

11. An electrode, comprising:
a current-collecting layer; and
an active layer disposed on the current-collecting layer, wherein the active layer comprises the electrode material as claimed in claim 1.

12. The electrode as claimed in claim 11, wherein the active layer consists of the electrode material.

13. A battery, comprising:
a positive electrode;
a separator; and
a negative electrode, wherein the negative electrode is separated from the positive electrode by the separator, wherein at least one of the positive electrode and the negative electrode is the electrode as claimed in claim 11.

14. A method for forming electrode material, which is used to forming the electrode material as claimed in claim 1, comprising:
providing a composition, wherein the composition comprises the active particle, the conductive additive, and the first polymer;
subjecting the composition to a spray pelletization process or a melt blending process to obtain the electrode material.

15. The method for forming electrode material as claimed in claim 14, when the composition is subjected to the spray pelletization process, wherein the composition further comprises a solvent, such that the active particle, the conductive additive, and the first polymer are uniformly dispersed in the solvent.
